(19) United States
(12) Patent Application Publication
(10) Pub. No.: US 2006/0233144 A1
(43) Pub. Date: Oct. 19, 2006

(54) Mobility support apparatus for mobile terminal

(76) Inventor: Yuji Matsumoto, Kawasaki (JP)

Correspondence Address: KATTEN MUCHIN ROSENMAN LLP, 575 MADISON AVENUE, NEW YORK, NY, 10022-2585, US

(21) Appl. No.: 11/451,747

(22) Filed: Jun. 13, 2006

Related U.S. Application Data
(63) Continuation of application No. PCT/JP03/16369, filed on Dec. 19, 2003.

(51) Int. Cl. H04Q 7/24

(52) U.S. Cl. 370/338

(57) ABSTRACT

A home agent, when receiving a binding update message containing designation of a priority level in such a status that unauthorized binding is registered in a binding cache, judges which priority level, the priority level designated in this binding update message or a priority level related to the unauthorized binding, is higher, then updates, when judging that the former is higher than the latter, the binding cache with the binging contained in this binding update message, and deletes the unauthorized binding.

### CROSS-REFERENCE TO RELATED APPLICATION

This application is a continuation of International Application PCT/JP2003/016369, filed on Dec. 19, 2003, the contents of which are herein wholly incorporated by reference.

### BACKGROUND OF THE INVENTION

1. Field of the Invention

The present invention relates to a mobility support apparatus (e.g., Home Agent: HA) for supporting position registration (binding update) of a mobile terminal (Mobile Node: MN).

2. Description of the Related Art

In a mobile IP (Mobile IPv4: refer to Non-Patent document 1, Mobile IPv6: refer to Non-Patent document 2) field, a mobile terminal (Mobile Node: MN) requests a home agent (HA) defined as a mobility support apparatus for mobility support by sending a position registration request (Binding Update: BU) message to the HA.

In a case where the MN sends the BU message to the HA, a negotiation using IPSec (Internet Protocol Security) is conducted between the MN and the HA, and the position registration is made based on this negotiation. This scheme strengthens the security.

There is, however, a possibility in which security information might leak out due to a loss and a theft of the MN and due to interception of communications between the MN and the HA. In this case, if an unlawful (unauthorized) user makes unauthorized position registration in the HA by use of the security information, even when a regular (authorized) user tries to make the position registration in the HA, there is such a case that an unable-to-make-the-position-registration status will continue. A method effective in canceling this status did not however, exist.

Problems inherent in the prior arts will hereinafter be described by exemplifying a case of Mobile IPv6 with reference to FIGS. 31 through 37. FIG. 31 is a diagram showing an example of a network configuration to which Mobile IPv6 is applied. In FIG. 31, a symbol M1 represents a mobile node of a user B (hinderer; spoofer). A symbol M2 designates a mobile node of an authorized user A (contractor). The mobile node M2 has a home-of-address (HoA) used in a home link, acquires a care-of-address (Care-of-Address: CoA) in a destination of movement (foreign link; foreign network), and makes position registration (binding update) in the HA. The symbols M3, M4 and M6 are general type of routers connected to an Internet M9.

The symbol M7 designates a mobility support apparatus (home agent: HA). The HA receives a position registration request (BU: Binding Update) message from the MN. The BU message contains the home-of-address HoA and the care-of-address CoA of the MN. The HA, when receiving the BU message, registers an associated relation (called “binding”) between the HoA and the CoA as a piece of position information of the MN in a storage area termed a binding cache (BC). Further, the HA, in the case of performing communications between the MN and a communication partner node (called a Correspondent Node: CN), the HA relays packets sent from both sides. At this time, the HA, when receiving the packet addressed to the MN, refers to the BC and encapsulates the packet with the present care-of-address CoA (of the binding) of the MN and transfers the encapsulated packet (to this CoA).

The symbol M8 represents a gateway disposed between an enterprise network M11 and the Internet M9 and has a gateway function. The symbol M9 stands for a general type of Internet. The symbol M11 represents a private network such as an enterprise network. Further, the gateway M8 takes a communication linkage with the home agent M7, thereby enabling the MN to access the enterprise network M11 through VPN (Virtual Private Network) communications. The symbol M12 denotes a wireless access point connected to the mobile node M1, the mobile node M2, etc by utilizing IEEE802.11x etc.

FIG. 32 shows an outline of an operation related to a position registration process based on Mobile IPv6 in the network system as illustrated in FIG. 31. In FIG. 32, the mobile node M2 having a home-of-address “HoA-M2”, when making a request for mobility support, receives a router advertisement (Router (Agent) Advertisement: RA) ((1) in FIG. 32). Then, the mobile node M2 generates, based on the RA, a care-of-address “CoA-M4” to be bound to “HoA-M2” ((2) in FIG. 32). Next, the mobile node M2 conducts a security negotiation (authentication process) with the home agent M7 ((3) in FIG. 32), and thereafter sends the BU message to the home agent M7 ((4) in FIG. 32). FIG. 33 shows an example of a structure of a BU message format. The home agent M7, when accepting the BU message, sets the associated relation (generates the binding) between “HoA-M2” and “CoA-M4” contained in this BU message, and registers this binding in the binding cache (BC) ((5) in FIG. 32). FIG. 34 shows an example of a BC table stored with the binding cache for every normal HoA.

FIG. 35 shows an outline of an operation in a case where the user B of the mobile node M1 unlawfully acquires the information on the mobile node M2 in the network system as shown in FIG. 31.

In FIG. 35, the mobile node M1, when making the request for the mobility support in a way that becomes a spoofer pretending to be a user of the mobile node M2 by use of the information acquired in the unauthorized manner, receives the router advertisement RA from the router M3 ((1) in FIG. 35), then generates a care-of-address “CoA-M3” based on this RA ((2) in FIG. 35), executes the authentication process with the home agent M7 ((3) in FIG. 35), and thereafter sends the BU message to the home agent M7 ((4) in FIG. 35). The home agent M7, when accepting the BU message, registers a spoofer's binding of “HoA-M2” and “CoA-M3” in the BC ((5) in FIG. 35).

It is assumed that the mobile node M2 thereafter performs the operation explained in FIG. 32. In this case, the mobile node M2 receives the RA from the router M4 ((6) in FIG. 35), generates “CoA-M4” ((7) in FIG. 35), then conducts the security negotiation with the home agent M7 ((8) in FIG. 35), and sends the BU message ((9) in FIG. 35).

At this time, the BC related to the spoofer's home-of-address “HoA-M2” has already been registered in the home agent M7, and hence the home agent M7 rejects the position registration from the mobile node M2. In this case, even when trying to register a new authentication key between the mobile node M2 and the home agent M7 by a security negotiation algorithm, this key is different from the key which is a falsified key of the spoofing user B and is therefore rejected. Accordingly, the mobile node M2 can not perform the communications because of being unable to make the position registration.

FIG. 36 shows an outline of an operation of the position registration in such a case that the user B (spoofer) acquires the mobile node M2 in the unauthorized manner in the network system as shown in FIG. 31. In FIG. 36, the user B becomes the spoofer behaving as the user A by abusing the mobile node M2 and executes the same operations as those in (1)-(5) explained in FIG. 35 ((1)-(5) in FIG. 6). In this case, even if the user A gets a new mobile node as a substitute for the mobile node M2 ((6) in FIG. 36) and performs the same operations (the position registration procedures of the new node: (7)-(10) in FIG. 36) as those in (6)-(9) in FIG. 35, the position registration of the spoofer has already been done, and therefore the new position registration is rejected with the result that the communications can not be performed.

Further, in the cases shown in FIGS. 35 and 36, the gateway M8 serving as an enterprise VPN-GW (router) is connected directly (which is a transparent connection at an IP level) to the home agent M7. Hence, there was a possibility that the user might acquire an address of the gateway M8 via the home agent M7 and might attack at the enterprise network M11 via the gateway M8. FIG. 37 shows an example of detecting a VPN address by intercepting and analyzing a WEP (Wired Equivalent Privacy) code sent from a wireless LAN in a status where the operations in (1) through (5) in FIG. 32 are carried out in the network system as illustrated in FIG. 31.

In FIG. 37, when the mobile node M2 accesses the enterprise network Mil, the position registration of the mobile node M2 in the home agent M7 is executed via the wireless access point M12 and the router M4 by the same operations (the position registration procedures) as those in (1)-(5) in FIG. 32, and thereafter the VPN connection between the home agent M7 and the gateway M8 is established by use of the home-of-address “HoA-M2” of the mobile node M2 that is defined as a local address within the enterprise network M11 ((1) in FIG. 37). Thereafter, the mobile node M2 can perform the communications with the enterprise network M11 ((2) in FIG. 37). Hereat, there occurs a possibility that if the unauthorized person intercepts the communications between the mobile node M2 and the wireless access point M12 by employing the node M1 ((3) in FIG. 37), peeps the WEP (Wired Equivalent Privacy) encryption sent between the wireless access point M12 and the mobile node M2, then decrypts the WEP encryption by use of a technology disclosed in, e.g., Non-Patent document 4 etc and detects an address of the home agent M7, the unauthorized person might do an unlawful attack at the home agent M7 via the general router M13 by employing the node M1 ((4) in FIG. 37).

In this case, the address of the home agent M7 is known, and hence the address (source address) of the home agent M7 can be detected directly from the data and information received on the side of the mobile node M2. Consequently, there is a possibility that the home agent M7 might accept an unauthorized request from the node (the node M1 etc) of the spoofer pretending to be a user of the mobile node M2.

[Non-Patent document 1] (Mobile IPv4)

http://www.ietf.org/rfc/rfc2002.txt

[Non-Patent document 2] (Mobile IPv6)

http://www.ietf.org/internet-drafts/draft-ietf-mobileip-ipv6-23.txt

[Non-Patent document 3] (WEP)

Intercepting Mobile Communications: The Insecurity of 802.11 (authored by Nikita Borisov Ian Goldberg, and David Wagner)

[Non-Patent document 4] (SSL)

http://www.ietf.org/rfc/rfc2246.txt?number=2246

### SUMMARY OF THE INVENTION

It is an object of the present invention to provide a technology capable of deleting already-conducted position registration.

It is another object of the present invention to provide a technology capable of preventing incapability of communications due to an attack at a mobility support apparatus.

According to a first mode of the present invention, a mobility support apparatus for a mobile terminal, having a storage unit stored with position information of the mobile terminal and controlling communications of the mobile terminal on the basis of the position information registered in the storage unit, comprises a priority level registering unit that registers a priority level of the position information registered in the storage unit, a communication unit, and update processing unit that judges, with respect to a position information update request received by the communication unit, whether or not a priority level contained in the position information update request is higher than a priority level of an update target position information within the storage unit, and updates, when judging that the priority level contained in the position information update request is higher, the update target position information with the position information contained in the position information update request.

According to the first mode, in the case where the storage unit is stored with the position registration information, when judging that the priority level in the position registration information is higher than the priority level contained in the position registration information update request, the associated position registration information in the storage unit is updated with the position registration information contained in this update request. Accordingly, if the position registration information registered in the storage unit is the unauthorized position registration information, this unauthorized position registration information is deleted from the storage unit by the operation described above. Thus, if the unauthorized position registration is conducted, this position registration can be eliminated, and the authorized position registration can be made.

Preferably, the update processing unit in the first mode executes the judging process about the update request sent from the mobile terminal.

Further, preferably the update processing unit in the first mode executes the judging process about the update request sent from a management terminal of the mobility support apparatus.

Thus, in the first mode, the position information registered by the mobile node is updated based on the position registration update request sent from the node different from the mobile node that is conducting the position registration in the position registration support apparatus.

Moreover, preferably, in the first mode, the mobility support apparatus further comprises a time measuring unit measuring a predetermined period of time when the storage unit is stored with the position information in which a highest priority level is set, and a rewriting unit rewriting, when the time measuring unit measures the predetermined period of time, the highest priority level into a lower priority level.

Further, preferably, the update processing unit in the first mode, when registering the position information containing the setting of the highest priority level in the storage unit, registers the position information in a way that assigns this information a priority level lower than the highest priority level.

Still further, the update processing unit in the first mode can be configured so as to judge that the priority level in the update request is higher if both of the comparison target priority levels are equal to each other but are not the highest priority level.

Yet further, the update processing unit in the first mode can be configured so as to judge that the priority level in the update request is higher if both of the comparison target priority levels are the highest priority level.

Moreover, a mobility support apparatus for a mobile terminal in a second mode of the present invention, having a storage unit stored with position information of the mobile terminal and controlling communications of the mobile terminal on the basis of the position information registered in the storage unit, comprises a communication unit, and an update processing unit that receives a position information update request containing first position information from a management terminal of the mobility support apparatus via the communication unit, rewrites update target position information within the storage unit with the first position information, thereafter receives a position information update request containing second position information from the mobile terminal via the communication unit, and rewrites the first position information within the storage unit into the second position information.

Preferably, the update processing unit in the first and second modes accepts, only when a sender of the position information update request received by the communication unit is a predetermined node, this position information update request.

A mobility support apparatus for a mobile terminal in a third mode of the present invention, having a storage unit stored with position information of the mobile terminal and controlling communications of the mobile terminal on the basis of the position information registered in the storage unit, comprises a communication unit, and an update processing unit that receives a position information update request sent from the mobile terminal having plural pieces of identifying information via the communication unit, and updates, if the storage unit is stored with the position information containing the mobile terminal identifying information different from the mobile terminal identifying information contained in the position information in this update request, the position information within the storage unit on the basis of the position information in the update request.

In this case, for instance, a preferable scheme is that plural pieces of identifying information have a superiority relationship, if the storage unit is registered with the position information containing the identifying information inferior to the identifying information in the update request, this position information is updated based on the position information in the update request.

Preferably, the mobility support apparatus in the first through third modes further comprises a transfer destination setting unit that sets transfer destination information of a packet in the position information stored in the storage unit, and a transfer control unit that forwards, if a source (sender) of the packet received by the communication unit is the mobile terminal associated with the position information in which the transfer destination information is set, this packet toward a transfer destination based on the transfer destination information from the communication unit.

Moreover, preferably, the transfer control unit, if a destination (recipient) of the packet received by the communication unit is the mobile terminal associated with the position information in which the transfer destination address is set, this packet toward a transfer destination based on the transfer destination information from the communication unit.

Furthermore, preferably, the mobility support apparatus in the first through third modes further comprises a unit that sets in a packet transmission-enabled status, in response to a request from a predetermined terminal, the mobile terminal associated with predetermined position information stored in the storage unit, and a relay processing unit that transmits, if the sender of the packet received by the communication unit is the predetermined terminal, this packet to the mobile terminal from the communication unit in accordance with the transmission-enabled status.

Further, preferably, the relay processing unit rewrites a source address of the packet that should be transferred to the mobile terminal into an address of the mobility support apparatus.

Still further, preferably, the relay processing unit relays a packet containing a message by which the mobile terminal is forced to send the position information update request.

Yet further, the relay processing unit relays a packet containing a message for stopping an operation of the mobile terminal.

Moreover, the mobility support apparatus in the first through third modes further comprises registering unit registering controlled target information representing a control target by the management terminal in specified position information stored in the storage unit in response to a request given from the management terminal, and control unit executing a process related to the position information containing the registration of the controlled target information on the basis of the control information received by the communication unit and given from the management terminal.

The controlled target information is, for example, an address of the network where the management terminal is located, or an address of the management terminal itself.

A mobile communication system in a fourth mode of the present invention comprises a mobile terminal, a first mobility support apparatus, a second mobility support apparatus, and a gateway disposed in a private network accessed by the mobile terminal, wherein the first mobility support apparatus accepts position registration from the mobile terminal and from the gateway, and establishes communications between the mobile terminal and the gateway via the first mobility support apparatus itself, and the second mobility support apparatus accepts, when judging that the mobile terminal is unable to perform the communications with the gateway via the first mobility support apparatus due to a rise in load on the first mobility support apparatus, the position registration from the mobile terminal and from the gateway, and establishes the communications between the mobile terminal and the gateway via the second mobility support apparatus itself.

Further, a mobile communication system in a fifth mode of the present invention comprises a mobile terminal, a mobility support apparatus, and first and second gateways disposed in a private network accessed by a mobile terminal, wherein the mobility support apparatus accepts position registration from the mobile terminal and from the first gateway, and establishes communications between the mobile terminal and the first gateway via the mobility support apparatus itself, and the second gateway makes, if a load on the first gateway exceeds a predetermined value, the position registration in a way that serves as (a proxy for) the first gateway in the mobility support apparatus, and takes over the communications with the mobile terminal from the first gateway.

Preferably, the second gateway in the fifth mode performs, when taking over the communications with the mobile terminal from the first gateway, a test as to whether the mobile terminal is an unauthorized mobile terminal or not, and requests, when judging from a result of the test that the mobile terminal is the unauthorized mobile terminal, the mobility support apparatus to execute a process of disconnecting the communications with the mobile terminal.

The present invention can be also specified as a position registration control method in the mobility support apparatus and as a communication path switching method, which have the same features as those of the mobility support apparatus and the mobile communication system described above.

### BRIEF DESCRIPTION OF THE DRAWINGS

FIG. 1 is an explanatory diagram showing a first embodiment of the present invention;

FIG. 2 is an explanatory diagram showing a second embodiment of the present invention;

FIG. 3 is an explanatory diagram showing a third embodiment of the present invention;

FIG. 4 is an explanatory diagram showing a fourth embodiment of the present invention;

FIG. 5 is an explanatory diagram showing a fifth embodiment of the present invention;

FIG. 6 is an explanatory diagram showing a sixth embodiment of the present invention;

FIG. 7 is an explanatory diagram showing a seventh embodiment of the present invention;

FIG. 8 is an explanatory diagram showing an eighth embodiment of the present invention;

FIG. 9 is an explanatory diagram showing a ninth embodiment of the present invention;

FIG. 10 is a sequence diagram showing an operational example in the ninth embodiment of the present invention;

FIG. 11 is an explanatory diagram showing a tenth embodiment of the present invention;

FIG. 12 is a sequence diagram showing an operational example in the tenth embodiment of the present invention;

FIG. 13 is a block diagram showing an example of a configuration of a mobility support apparatus (home agent (HA));

FIG. 14 is a block diagram showing an example of a configuration of a mobile node (MN);

FIG. 15 is a block diagram showing an example of a configuration of a management node;

FIG. 16 is a diagram showing one example of a binding table in which a priority level is set in a binding cache;

FIG. 17 is a diagram showing one example of a binding cache table in which a fixed destination address is set in the binding cache;

FIG. 18 is a diagram showing one example of the binding cache table in which the priority level is set in the binding cache (BC entry) (HoA);

FIG. 19 is a diagram showing one example of the binding cache table in which the priority level and a priority level setting-enabled address are set in the binding cache;

FIG. 20A is a diagram showing one example of a table stored with information about a plural HoA-related registration process;

FIG. 20B is an explanatory diagram of a control providing function;

FIG. 21 is a diagram showing an example of a minding update message containing designation of the priority level;

FIG. 22 is a diagram showing an example of a binding update message in which the priority level is defined by a length of the message;

FIGS. 23A, 23B and 23C are diagrams showing one example of a plural HoA registration request message;

FIG. 24 is a diagram showing an example of a normal binding refresh request message;

FIG. 25 is a diagram showing one example of a stop message with respect to the mobile node;

FIG. 26 is a flowchart showing an example of a process by the mobility support apparatus (HA);

FIG. 27 is a flowchart showing an example of a preferential position registration process;

FIG. 28 is a flowchart showing an example of a valid address designation process in the binding cache;

FIG. 29 is a flowchart showing an example of a binding cache table update process;

FIG. 30 is a flowchart showing an example of a plural home-of-address related process request and policy-relating process registration;

FIG. 31 is a diagram showing an example of a configuration of a network in which the operation is based on Mobile IPv6;

FIG. 32 is a diagram showing an example of a case where the position registration process is executed based on Mobile IPv6 in the network shown in FIG. 31;

FIG. 33 is a diagram showing a normal binding update message;

FIG. 34 is a diagram showing a normal binding cache table;

FIG. 35 is an explanatory diagram showing a case in which an unauthorized user as a spoofer makes the position registration in the home agent, and an authorized user can not make the position registration due to this spoofing;

FIG. 36 is an explanatory diagram showing a case in which the position registration in the home agent is done by abusing the authorized mobile node in an unauthorized manner; and

FIG. 37 is an explanatory diagram showing a case in which a WEP key is acquired at an access point in a wireless LAN, then an address of the home agent is obtained, and the home agent is attacked.

### DETAILED DESCRIPTION OF THE PREFERRED EMBODIMENTS

Embodiments of the invention will hereinafter be described with reference to the drawings. Configurations in the embodiments are exemplifications, and the invention is not limited to the configurations in the embodiments.

### First Embodiment

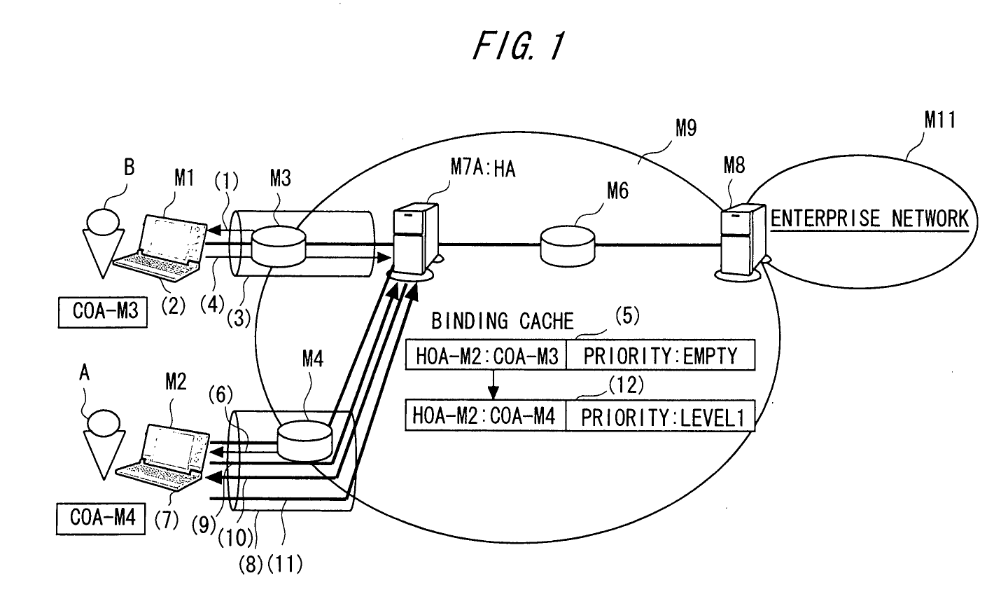

FIG. 1 is an explanatory diagram showing a first embodiment of the present invention. FIG. 1 shows a network system including a home agent (HA) M7A serving as a mobility support apparatus for a mobile terminal (mobile node (MN)) according to the present invention. The home agent M7A, which is connected to an Internet M9, supports registering a position of the mobile node (MN) according to Mobile IPv6, and relays packets transmitted and received between the MN and a communication partner terminal (correspondent node: CN).

The mobile node can register self position management information in the home agent M7A through routers such as a router M3 and a router M4 connected to the Internet M9. FIG. 1 illustrates a mobile node M2 used by a regular (authorized) user A who subscribes a mobile communication service utilizing the home agent M7A, and a mobile node M1 used by an unlawful (unauthorized) user B.

Further, the home agent M7A is connected via a router M6 to a gateway M8 that connects an enterprise network M11 to the Internet M9. The mobile node M2 registers a self-position in the home agent M7A and can thus perform communications with nodes (unillustrated) in the enterprise network M11 via the home agent M7A, the router M6 and the gateway M8.

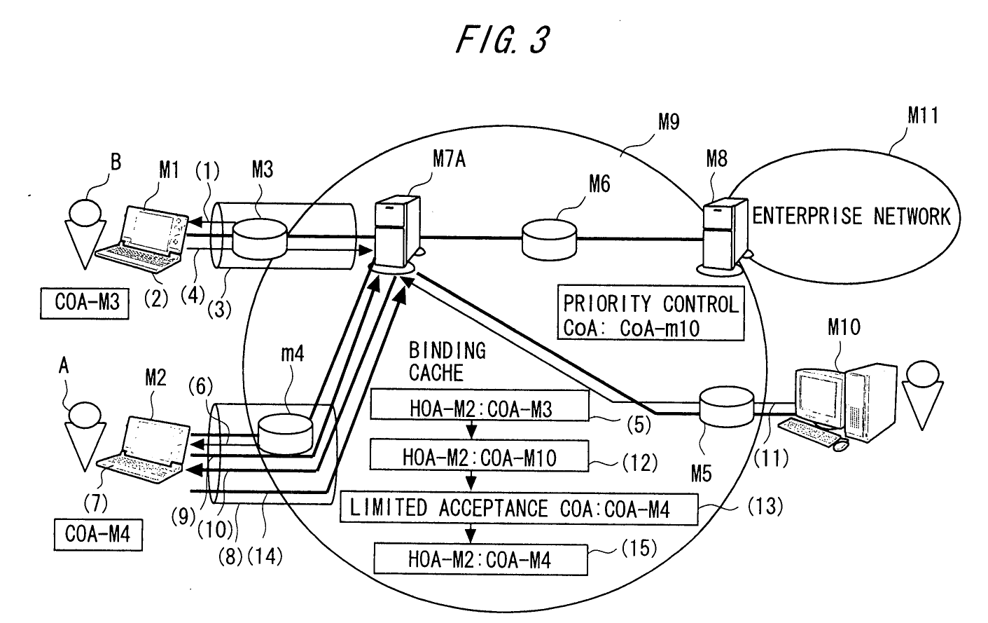

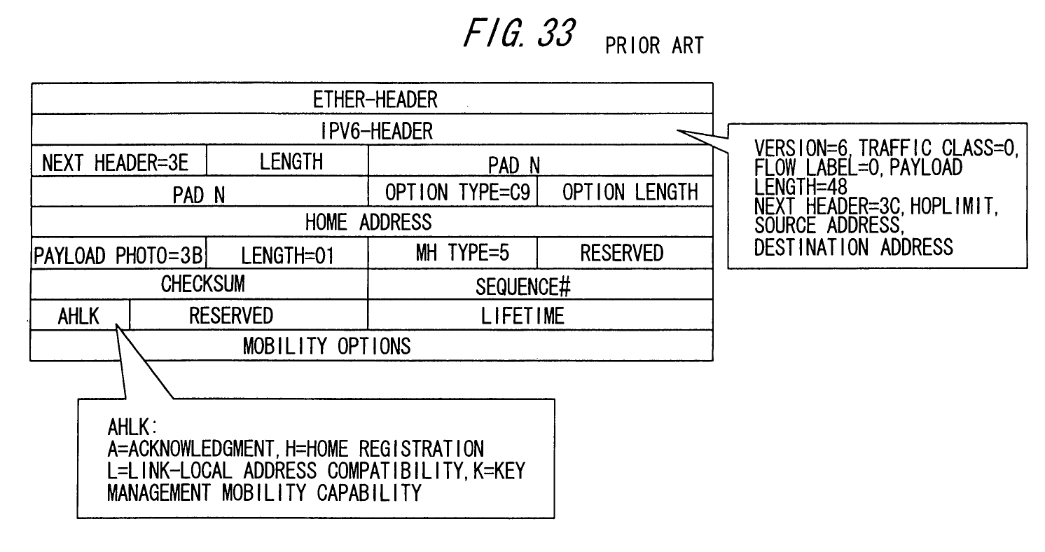

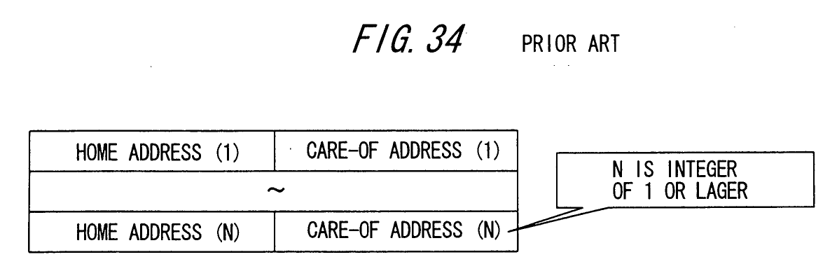

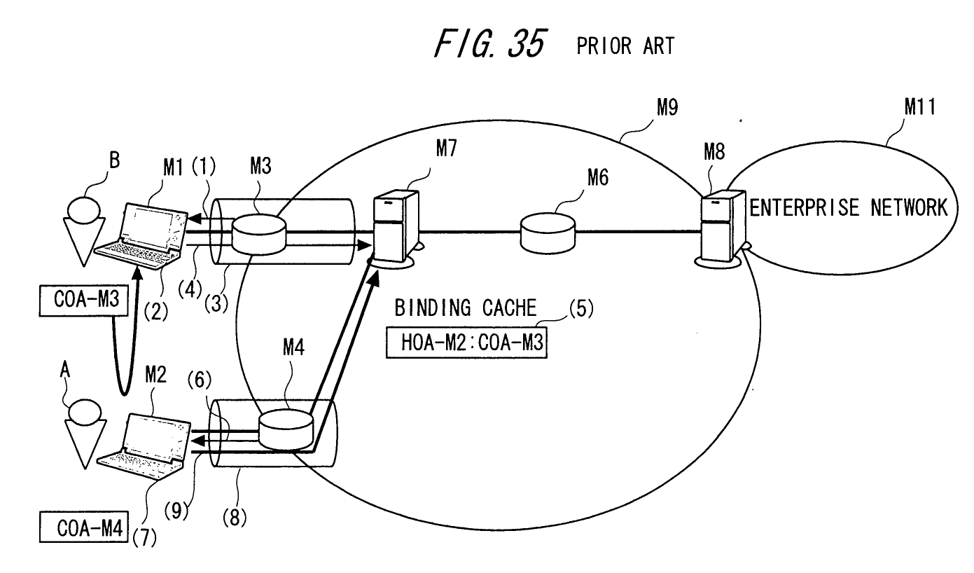

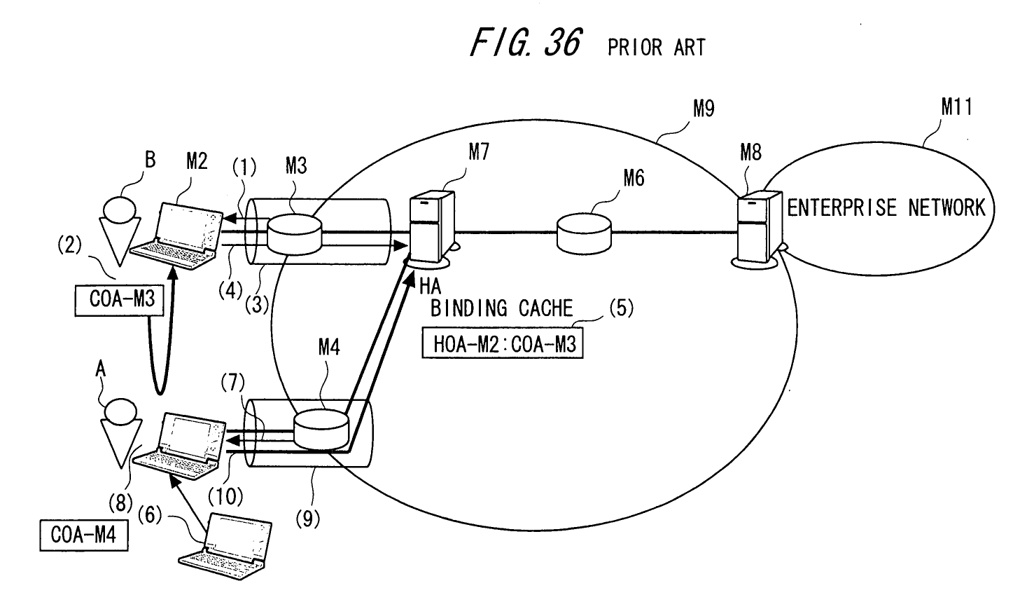

FIG. 1 shows a case where a spoofer (the user B) makes a request for the mobility support by “user spoofing” pretending to be the authorized user A in a way that employs the mobile node M1. In this case, the mobile node M1 receives a router advertisement (RA) from the router M3 ((1) in FIG. 1). Then, the mobile node M1 generates a care-of-address “CoA-M3” ((2) FIG. 1). Next, the mobile node M1 makes a negotiation for security with the home agent M7A in a way that becomes the spoofer behaving as the mobile node M2 (by use of “HoA-M2”) ((3) in FIG. 3). Thereafter, the mobile node M1 sends a position registration update (binding update) request message (Binding Update: BU: see FIG. 33) for notifying the home agent M7A of the care-of-address “CoA-M3” associated with (bound to) a home-of-address “HoA-M2” of the mobile node M2 ((4) in FIG. 1).

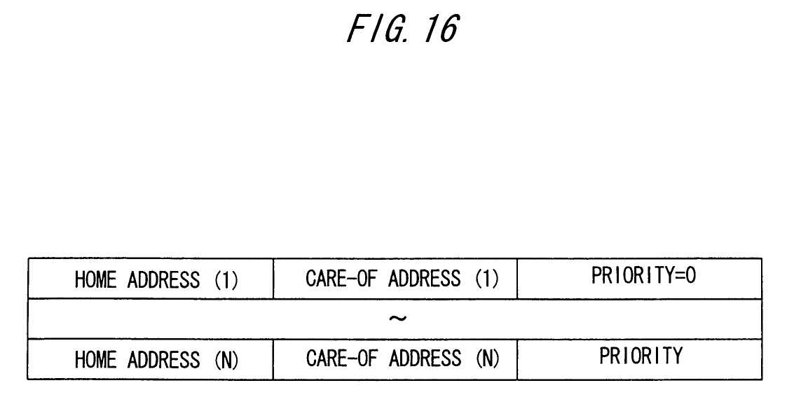

The home agent M7A, when receiving the BU from the mobile node M1, binds “HoA-M2” and “CoA-M3” together. Such a relationship and binding between the home-of-address and the care-of-address is generically called “binding”. The home agent M7A registers the binding as the position management information in an area (which is called “Binding Cache: BC”) prepared on a storage device (e.g., a RAM, a hard disc, etc.) held by the home agent M7A. The BC is managed by way of a BC table (see, e.g., FIG. 16) prepared with entries on a HoA-by-HoA basis ((5) in FIG. 1).

Thereafter, when the mobile node M2A of the authorized user A requests the home agent M7A for the mobility support, the mobile node M2 receives the RA from the router M4 ((6) in FIG. 1) and generates a care-of-address “CoA-M4” ( (7) in FIG. 1), and a negotiation (authentication process) for the security is conducted between the mobile node M2 and the home agent M7A ((8) in FIG. 1). Thereafter, the mobile node M2A sends the BU for notifying the home agent M7A of the care-of-address “CoA-M4” bound to (associated with) the home-of-address “HoA-M2” ((9) in FIG. 1).

In the home agent M7A, however, the binding information about the home-of-address “HoA-M2” is registered in a protected status by the security. Therefore, the home agent M7A does not accept the BU and sends “abnormality” via a binding acknowledgment (BA) message back to the mobile node M2 ((10) in FIG. 1).

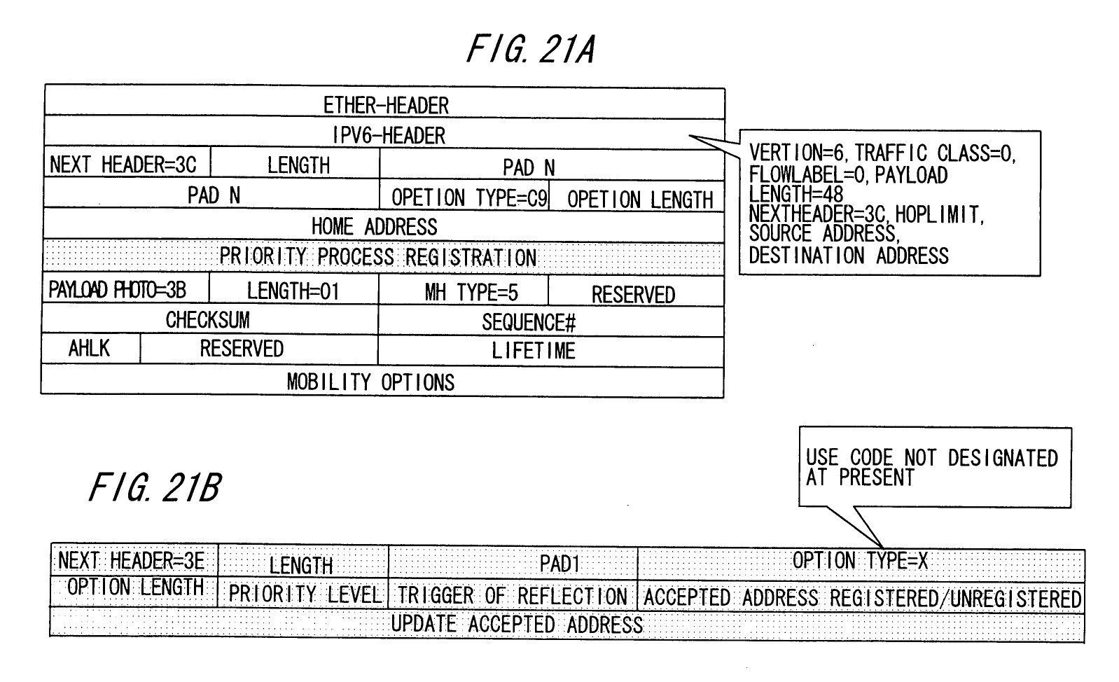

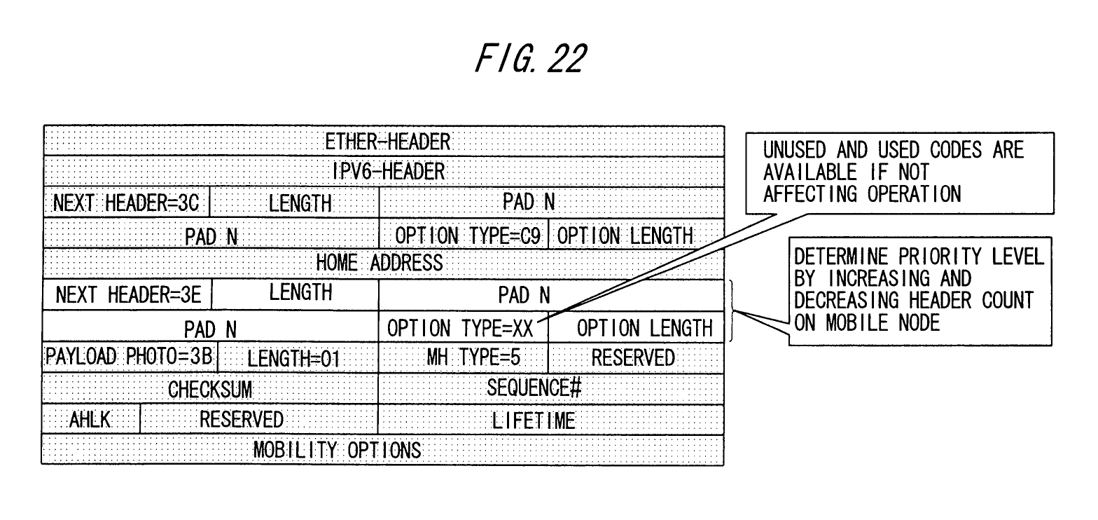

The mobile node M2 accepting this abnormality generates and sends the BU related to “HoA-M2” assigned a priority level (assigned an indication level information showing the priority level) with respect to the binding ((11) in FIG. 1). As the BU assigned the priority level, it is possible to apply, for example, a BU message containing a header field (a field stored with “priority level”) for registration a priority process as shown in FIG. 21 and a BU message in which the priority level is designated by a numerical value entered in a predetermined header field as shown in FIG. 22.

The home agent M7A, upon receiving the BU assigned with the priority level, deduces the BC related to “HoA-M2” from the home-of-address contained in this BU, and compares the priority level of the binding that is set in this BC with the priority level contained in the BU. At this time, when judging that the priority level contained in the BU is higher than the priority level set in the BC, the home agent M7A accepts this BU and updates the BC related to “HoA-M2” with the binging (information) acquired from this BU ((12) in FIG. 1). This scheme deletes (eliminates) the unauthorized biding. Further, the authorized binding from the mobile node M2 is registered in the BC. The home agent M7A, in the case of registering the BC (new registration and update registration) in the storage device, registers the priority level corresponding to this BC in a way that associates the priority level with the BC (see FIG. 16).

It is to be noted that if the priority level is not designated in the BU received by the home agent M7A (the BU containing none of the designation of the priority level is called a “general BU”), the priority level (indication level information) for the position registration (Binding Update) in the binding cache BC on the basis of this general BU is “EMPTY (Priority=0)” representing non-designation. The BU containing the designated priority level (assigned the indication level information) is called a “particular BU”.

In the example shown in FIG. 1, the BU transmitted in (4) is the general BU, and hence the priority level of the position registration based on this general BU is “non-designation”. The priority level (rank) about the “non-designation” is the lowest level. By contrast, the BU transmitted in (11) is the particular BU, and the priority level “LEVEL 1” designated in this particular BU is prior to the priority level “non-designation”. With this priority scheme, the unauthorized BC is deleted, and the binding based on the particular BU of this time is registered (updated) as the BC.

Note that in the description according to FIG. 1, the mobile node M1 sends the BU containing none of the priority level assigned ((4) in FIG. 1). In place of this, even in the case of transmitting the BU containing the designated priority level in (4) in FIG. 1, if the BU containing the designation of the priority level higher than the priority level designated in this BU is transmitted from the mobile node M2 ((11) in FIG. 1), in the same way as the above, the unauthorized position registration is eliminated, and the authorized position registration can be done.

### Second Embodiment

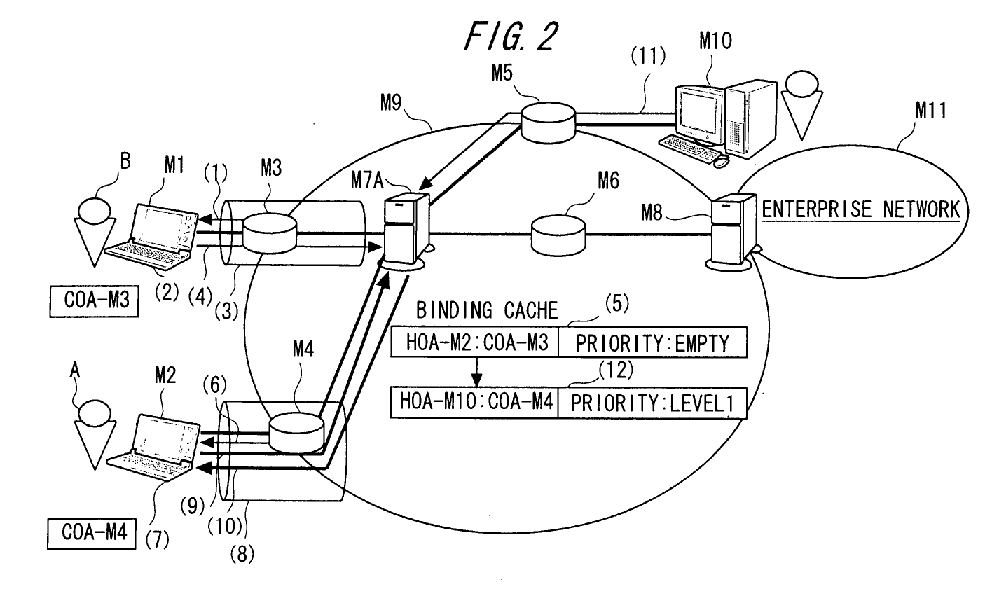

FIG. 2 is an explanatory diagram showing a second embodiment of the present invention. A configuration of a network system illustrated in FIG. 2 is substantially the same as the network system shown in FIG. 1. In the second embodiment, however, a management node M10 of the home agent M7A is connected to the home agent M7A via the router M5 on the Internet. Except this point, the network configuration in the second embodiment is the same as in the first embodiment.

In the second embodiment, the management node M10 controls the registration (update) of the BC in the home agent HA. In FIG. 2, the procedures (1) through (10) are the same as the procedures (1) through (10) shown in FIG. 1, and hence their explanations are omitted.

In (11) in FIG. 2, an administrator of the home agent M7A receives information purporting that the position registration can not be done from the user A, and an unlawfully registered BC is deleted on the side of the administrator (the management node M10). Therefore, the management node M10 sends the BU assigned the indication level information to the home agent M7A. This BU is an update request (Binding Update) containing temporary biding information for the BC associated with the home-of-address “HoA-M2”.

The home agent M7A, when receiving the BU containing the priority level from the management node M10, with the unlawfully registered BC being deemed as an update target (the BC being deduced from the HoA), compares the priority level (the priority level of the BU registered last time) registered in this BC with the priority level designated in the BU of this time, then, when judging that the priority level of this time is higher, accepts the BU of this time and updates the associated entry in the BC. Thus, the unauthorized binding information can be deleted. Note that the BC table shown in FIG. 16 and the BU messages shown in FIGS. 21 and 22 can be applied also in the second embodiment.

Moreover, a possible scheme is that the management node M10, if the home agent M7A updates the BC with the BU given from the management node M10, associates (sets) a condition used for the mobile node M2 of the authorized user (the user A) to take over this BC with (in) the home agent M7A. In this case, the home agent M7A updates the BC, corresponding to the BU that meets the takeover condition for taking over from the mobile node M2.

A further possible scheme is that the home agent M7A changes a structure of security algorithm information related to the position registration in response to a request given from the management node M10. In this case, it is possible to make such setting that the home agent M7A does not accept the BU from the “CoA-M3” (i.e., from the mobile node M1).

The setting described above can be actualized in the way that the management node M10 sends the BU message containing information for the setting to the home agent M7A or that the management node M10 sends a message different from the BU to the home agent M7A.

In a case where the mobile node M2 performs again the position registration in the home agent M7A, for instance, the user A acquires, from the administrator's side, the BC takeover condition information based on the temporary binding that is updated in the home agent M7A by means of handover, a telephone, a mail service and other communications, and sends the BU in which this takeover condition information is reflected from on the mobile node M2.

Herein, the home agent M7A refers to the takeover condition information set in the BU sent from the mobile node M2, and, when thus judging that the takeover condition is satisfied, updates the BC based on the temporary binding information with the binding information set in this BU. Thus, the mobile node M2 can register the self position information (binding) in the home agent M7A.

It is to be noted that in the example shown in FIG. 2, the unauthorized BC (HoA-M2: CoA-M4) is updated with the temporary binding “HoA-M10: CoA-M4” through the BU from the management node M10. Thus, the care-of-address structuring the temporary binding is set in (changed into) the care-of-address “CoA-M4” of the mobile node M2 in the present position, whereby the management node M10 acting as a proxy can register the care-of-address of the mobile node M2.

### Third Embodiment

FIG. 3 is an explanatory diagram showing a third embodiment of the present invention. A configuration of a network system illustrated in FIG. 3 is substantially the same as the network system shown in FIG. 2. In the third embodiment, the management node M10 controls the registration (update) of the BC in the home agent HA.

In the third embodiment, the priority level corresponding to the BC is not set in the BC table. A predetermined care-of-address CoA serving as a “priority control CoA” is, however, set in the home agent M7A in the third embodiment. The home agent M7A, when receiving the BU containing the priority control CoA, preferentially registers the binding (containing the priority control CoA) based on this BU in the BC.

Herein, the home agent M7A is subjected to filtering setting for preferentially registering the binding based on the BU containing designation of a care-of-address “CoA-M10” of the management node M10.

With this filtering setting, the home agent M7A preferentially registers the binding containing the designation of the care-of-address “CoA-M10” of the management node M10 with respect to the specified home-of-address. This type of filtering setting can be executed directly in the home agent M7A or by remote control from the management node M10.

In FIG. 3, the assumption is such a case that in the procedures (1) through (10), in the same way as by (1) through (10) in FIG. 1, the user B becomes the spoofer behaving as the mobile node M2 and thus registers the unauthorized binding “HoA-M2: CoA-M3” in the BC, and the position registration by the mobile node M2 of the user A is rejected due to this unauthorized registration.

In this case, the administrator receives notification purporting that the position registration can not be done from the user A via a variety of communication means. Then, the administrator deletes the registration of the unauthorized binding by operating the management node M10. The management node M10, according to the operation by the administrator, sends the BU for registering the temporary binding “HoA-M2: CoA-M10” containing the priority control CoA to the home agent M7A ((11) in FIG. 3).

The home agent M7A receives the BU from the management node M10, and recognizes from the care-of-address “CoA-M10” designated in this BU that the binding based on this BU should be preferentially registered according to the filtering setting that has been preset in the home agent M7A itself. The home agent M7A specifies, based on this recognition, the unauthorized BC “HoA-M2: CoA-M3” related to the home-of-address “HoA-M2” contained in the BU from the BU table, and updates this BC with the binding “HoA-M2: CoA-M10” based on the BU. With this scheme, the unauthorized BC is deleted ((12) in FIG. 3).

Thereafter, the management node M10 executes the setting that helps the mobile node M2 update the BC “HoA-M2: CoA-M10” in the home agent M7A. For example, the management node M10 transmits, to the home agent M7A, the setting information with a purport of limitedly accepting only the BU containing designation of a foreign link (which is herein CoA-M4) where the mobile node M2 is located at the present with respect to the HoA-M2.

The home agent M7A, upon receiving the setting information, sets CoA-M4 as “limited acceptance CoA” according to this setting information. With this setting, the home agent M7A, with respect to HOA-M2, comes to a status of accepting only the BU containing the limited acceptance CoA, i.e., only the BU notifying of “HoA-M2: CoA-M4” ((13) in FIG. 3).

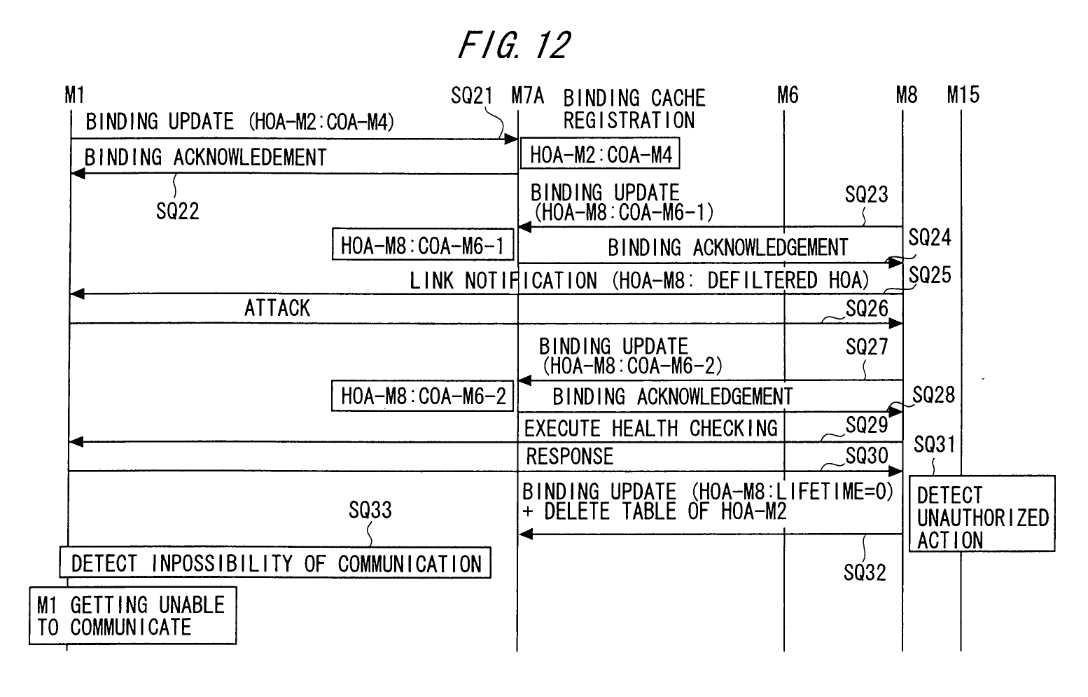

Thereafter, the mobile node M2 sends the BU for notifying of “HoA-M2: CoA-M4” to the home agent M7A ((14) in FIG. 12). Then, the home agent M7A updates “HoA-M2: CoA-10” in the BC with the binding “HoA-M2: CoA-M4” specified from the BU. Thus, the mobile node M2 can perform again the position registration.

### Fourth Embodiment

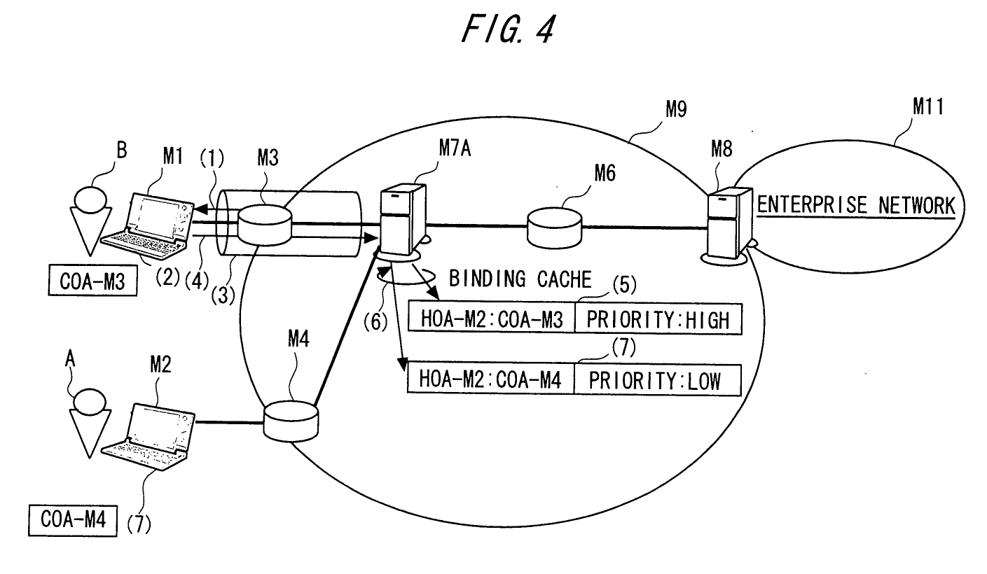

FIG. 4 is an explanatory diagram showing a fourth embodiment of the present invention. A configuration of a network system illustrated in FIG. 4 is substantially the same as the network system shown in FIG. 2. According to the fourth embodiment, in the same manner as in the first embodiment, the MN controls the registration (update) of the BC in the HA.

The home agent M7A, upon receiving the BU in which the priority level is designated, compares the priority level contained in this BU with the priority level so registered as to be associated with the update target BC (which is termed a “registration priority level”), thereby judging whether the priority level in the BU is higher than the registration priority level or not. At this time, if both of the priority levels are the highest levels (the top priority levels), the home agent M7A judges that the priority level in the BU is not higher than the registration priority level. Therefore, if the unauthorized binding (BC) is registered at the highest priority level, this binding becomes unable to be deleted or updated. The fourth embodiment solves this kind of problem.

In the fourth embodiment, the home agent M7A has a timer for measuring a predetermined period of time. The home agent M7A, when registering the BC with the binding of which the priority level is the highest level (the top priority level), starts measuring the time by use of the timer. The home agent M7A, when the timer has measured the predetermined period of time (timeout), changes the priority level set in the BC to a level lower than the highest level.

FIG. 4 illustrates a case in which the user B, in the procedures (1) through (5), becomes the spoofer behaving as the mobile node M2 by employing the mobile node M1 and registers the unauthorized binding at the top priority level.

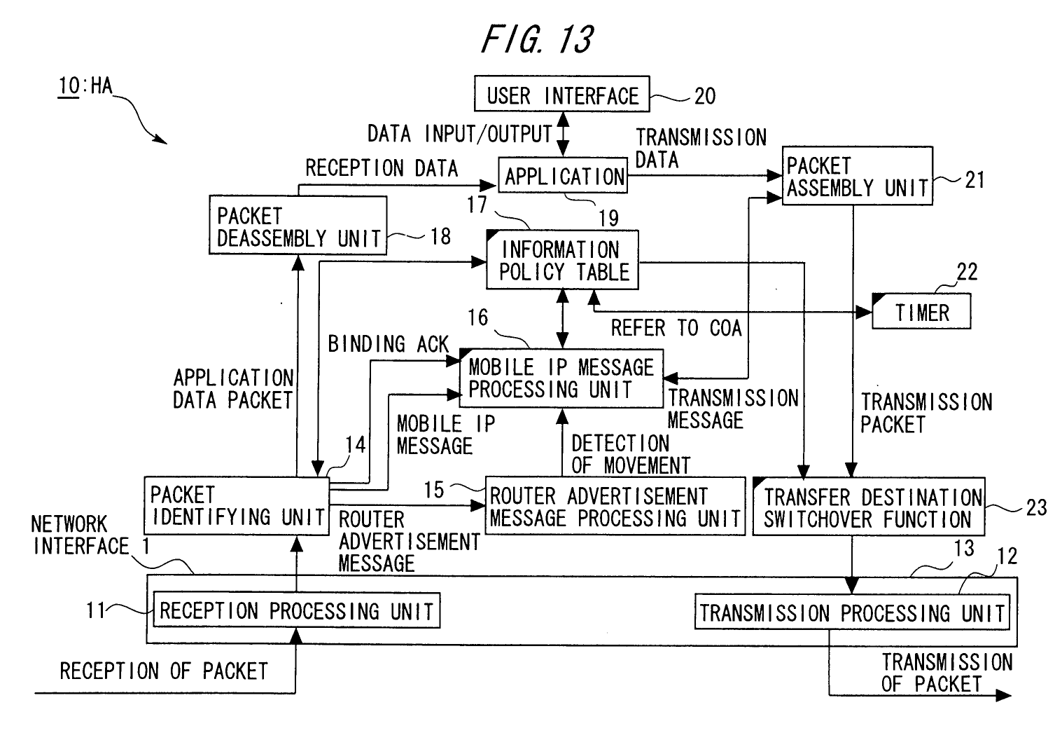

In this case, the home agent M7A registers the “HoA-M2: CoA-M3” at the top priority level (Priority: High) in the BC according to the BU sent from the mobile node M1 ((5) in FIG. 13). At this time, the home agent M7A starts measuring the predetermined period of time by employing the timer ((6) in FIG. 13).

Then, the home agent M7A, when the timer comes to the timeout, changes the priority level corresponding to the BC down to a lower level (Priority: Low) from the highest level ((7) in FIG. 13).

Thereafter, if the mobile node M2 sends the BU containing the designation of the top priority level (Priority: High), by the same operation as in the first embodiment, the unauthorized biding is updated with the binding based on the BU sent from the mobile node M2. Thus, the unauthorized binding is deleted, and the authorized binding is registered in the BC.

As discussed above, in the fourth embodiment, the home agent M7A rewrites the top priority level registered in the BC into the lower level after the elapse of the predetermined period of time. Accordingly, the BC is registered at the top priority level, whereby this BC can be prevented from not being updated.

Note that an available scheme is that if the priority level in the BU and the registration priority level are equal in their levels lower than the highest level, the home agent M7A judges that the priority level in the BU is not higher than the registration priority level. Alternatively, the home agent M7A may judge that the priority level in the BU is higher than the registration priority level.

Moreover, the following configuration can be applied as a substitute for the configuration that, as described above, the home agent M7A has the timer and changes the registration priority level after the predetermined period of time. For instance, the home agent M7A, in the case of registering the BC table with the binding information in which the top priority is designated in the BU, replaces the priority level “top priority” with a predetermined priority level lower than this top priority level and thus registers the replaced priority level.

Alternatively, the home agent M7A, in the case of comparing the priority level in the BU with the registration priority level, if the both of the priority levels are the top priority levels, preferentially registers the binding information based on this BU. Namely, the home agent M7A judges that the priority level in the BU is higher than the registration priority level.

It is also possible to delete the BC with the priority level registered as the highest level and to update with the arbitrary binding information also by providing the home agent M7A with these functions.

### Fifth Embodiment

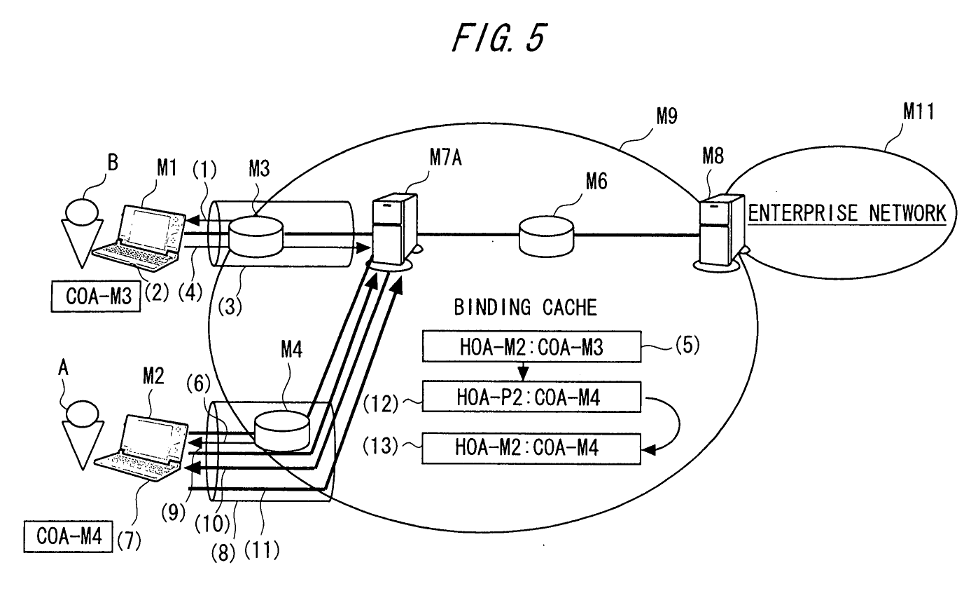

FIG. 5 is an explanatory diagram showing a fifth embodiment of the present invention. A configuration of a network system illustrated in FIG. 5 is substantially the same as the network system shown in FIG. 2. According to the fifth embodiment, in the same manner as in the first embodiment, the MN controls the registration (update) of the BC in the HA.

The mobile node M2 has a plurality of home-of-addresses. In an example shown in FIG. 5, the mobile node M2 has home-of-addresses “HoA-M2” and “HoA-p2”. Then, “HoA-p2” is preferential to “HoA-M2” in the position registration. A policy about such preferentiality of the HoA is preset in the home agent M7A. It should be noted that the fifth embodiment does not include executing the setting of the priority level in the BU and the registration of the priority level in the BC table.

FIG. 5 shows a case in which the user B becomes the spoofer behaving as the mobile node M2 by employing the mobile node M1 and registers the unauthorized position registration. Namely, substantially in the same procedures as the procedures shown in (1) through (5) in the first embodiment, the home agent M7A registers the binding “HoA-M2: CoA-M4” in the BC according to the BU sent from the mobile node M1 ((1) through (5) in FIG. 5).

Thereafter, when the mobile node M2 requests the home agent M7A for the position registration related to the home-of-address “HoA-M2”, as the BC has already been registered, the mobile node M2 receives the BA representing the rejection of update (“abnormality” from the home agent M7A ((6) through (10) in FIG. 5). This is the same as in the first embodiment (refer to (6) through (10) in FIG. 1).

Then, the mobile node M2 generates the BU using the home-of-address “HoA-p2” prior to “HoA-M2” and sends the BU to the home agent M7A ((11) in FIG. 5).

The home agent M7A registers the BU related to “HoA-p2” in the BC table ((12) in FIG. 5). Thereupon, the home agent M7A updates the BC according to a predefined setting (policy) with respect to “HoA-M2”.

Herein, the policy set in the home agent M7A is given as follows. In a case where the BC related to “HoA-M2” is registered, if the binding related to “HoA-p2” prior to “HoA-M2” is registered in the BC, a care-of-address CoA specified by the binding related to this “HoA-p2” is reflected in “HoA-M2”.

Hence, the home agent M7A, in the case of registering the binding related to “HoA-p2” in the BC, reflects the care-of-address “CoA-M4” bound to this “HoA-p2” in the BC entry of “HoA-M2”. To be specific, the home agent M7A rewrites “HoA-M2: CoA-M3” related to “HoA-M2” into “HoA-M2: CoA-M4” ((13) in FIG. 5). Thus, the unauthorized binding is deleted, and the BC is updated with the authorized binding.

The process described above can be modified as below. Specifically, the home agent M7A, upon receiving the BU related to “HoA-p2”, searches for the BC (binding cache entry) related to the home-of-address “HoA-M2” lower in its order than “HoA-p2” from the BC table. At this time, when the BC related to “HoA-M2” is retrieved, the home agent M7A reflects the care-of-address bound to “HoA-p2” in the retrieved BC. At this time, if the care-of-address bound to “HoA-p2” is “CoA-M4” the unauthorized binding “HoA-M2: CoA-M3” can be rewritten into “HoA-M2: CoA-M4”. In this case, there is no labor of registering the binding related to “HoA-p2” in the BC.

A further available scheme is that the home agent M7A overwrites the binding related to “HoA-M2” with the binding related to “HoA-p2”. In this case, “HoA-p2” is used as the home-of-address of the mobile node M2.

### Sixth Embodiment

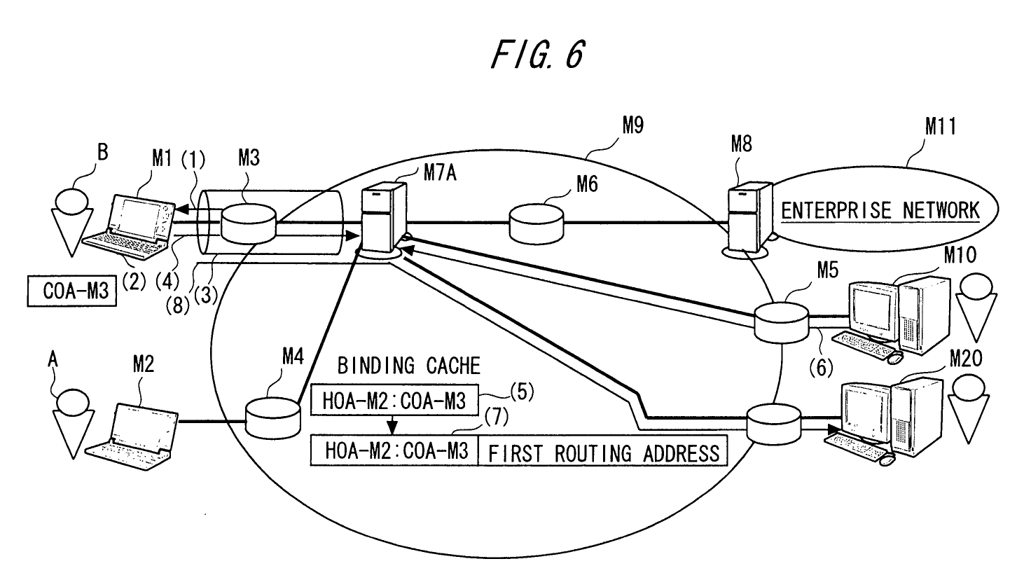

FIG. 6 is an explanatory diagram showing a sixth embodiment of the present invention. A configuration of a network system illustrated in FIG. 6 is substantially the same as the network system shown in FIG. 1. In the sixth embodiment, however, the management node M10 as shown in FIG. 2 is connected to the Internet M9 via the router M5, and a node M20 having a fixed destination address (a first routing address: First Routing Address) is connected to the Internet M9 via a router.

In the sixth embodiment, the home agent M7A has a function of preferentially transferring a packet sent from the MN to a routing destination in accordance with designation of the routing destination of the packet from the MN of which the home-of-address (HoA) is registered in the BC.

An arbitrary address is designated as the routing destination. In an example illustrated in FIG. 6, an address of the node M20 is designated. For instance, the management node M10 can notify of the designation of the routing destination. This notification contains at least the home-of-address HoA and the designated address. The home agent M7A, when receiving the notification, specifies the BA related to this HoA and registers the designated address as a first routing address in a way that associates this designated address with the BC.

The management node M10 also can, however, designate a value purporting non-designation of the routing destination (which is referred to as “non-designation value” and takes a value (e.g., “0”) unused for, e.g., the normal routing). In this case, the home agent M7A executes a normal routing process of transferring the packet to a destination (address) set in the packet sent from the MN.

Namely, the management node M10 sets one of the designated address and non-designation value with respect to an arbitrary home-of-address HoA in the home agent M7A. With this setting, the management node M10 can transfer the packet (invariably passing through the home agent M7A) from the arbitrary home-of-address HoA to an original destination address set in this packet or to an arbitrarily designated address from the home agent M7A.

Note that Mobile IPv6 has an option in which the CN and the MN perform the communications through no intermediary of the HA. In the sixth embodiment, however, this option is not employed.

An assumption in FIG. 6 is that the user B becomes the spoofer behaving as the mobile node M2 by employing the mobile node M1 and registers the unauthorized binding in the home agent M7A (refer to (1) through (5) in FIG. 6: the operations are the same as those in (1) through (5) in FIG. 3 explained in the third embodiment). With this scheme, there comes to a status of registering the unauthorized binding “HoA-M2: CoA-M3” in the BC of the home agent M7A.

In this status, the management node M10 sends, to the home agent M7A, a message for designating the routing destination for “HoA-M2” according to an operation of the administrator ((6) in FIG. 6). This message contains an address of a node M20 designated for “HoA-M2”.

The home agent M7A, upon receiving the message from the management node M10, registers the address of the node M20, which is contained in the message in a way that associates the address with the BC having the binding “HoA-M2: CoA-M3” according to this message ((7) in FIG. 6).

Thereafter, the home agent M7A, when receiving the packet from the mobile node M1 and recognizing that a source address of this packet is “HoA-M2”, changes a destination address of this packet to the designated address (the address of the node M20) registered with respect to the BC having the home-of-address “HoA-M2”, and thus transfers the packet. With this operation, the packet from the mobile node M1 reaches the node M20 without arriving at the original destination ((8) in FIG. 6).

Thus, the home agent M7A changes, based on the control of the management node M10, the destination of the packet sent from the unauthorized mobile node M1 to the node M20. This scheme makes it possible to prevent the packet based on the unauthorized position registration from flowing into the network.

Further, the packet addressed to “HoA-M2”, if normal, reaches the mobile node M1 via the home agent M7A. For this type of packet, the home agent M7A, just when recognizing that the destination address of the packet is “HoA-M2”, refers to the designated address set for “HoA-M2”, and transfers the packet to the node M20. Thus, it is feasible to prevent the packet addressed to “HoA-M2” from reaching the unauthorized mobile node M1.

It is to be noted that a scheme as a substitute for the scheme described above is possible, wherein the home agent M7A transfers the packet from the mobile node M1 to the original destination and at the same time forwards this packet to the designated address set with respect to the home-of-address (BC). Thus, the node M20 on the side of the administrator can acquire the packet from the unauthorized mobile node.

Alternatively, an available scheme is that the home agent M7A, when receiving the packet from the mobile node M1, encapsulates this packet and thus forwards the encapsulated packet to the designated address (the node M20), while the node M20 decapsulates this packet, creates a copy of the decapsulated packet, then stores one of the original packet and the copied packet, and transfers the other packet to the original destination.

### Seventh Embodiment

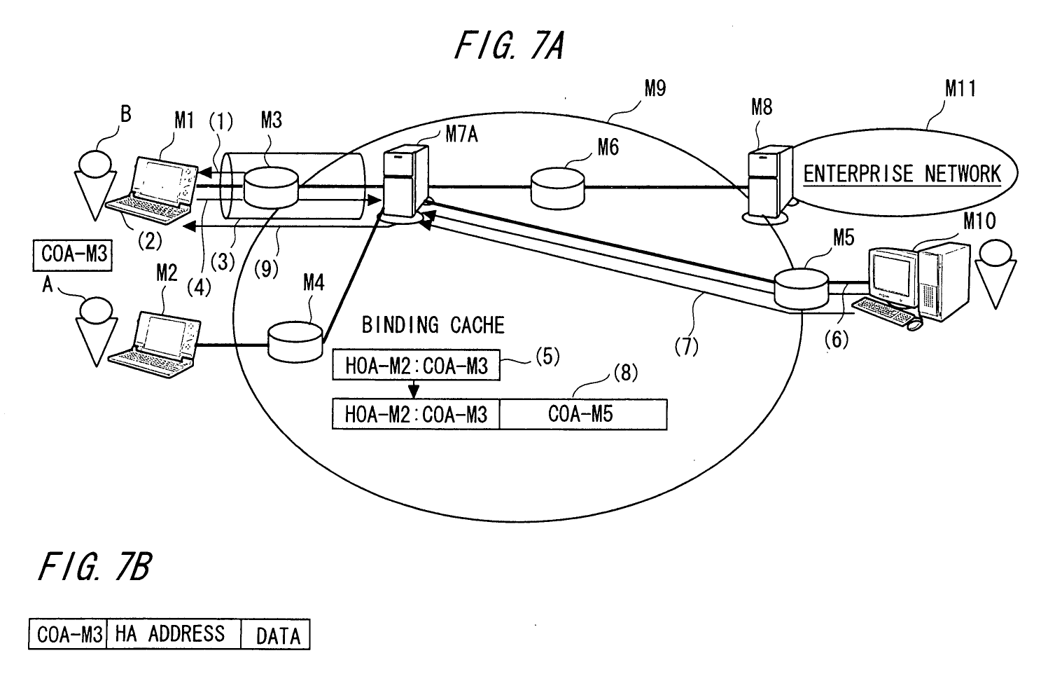

FIG. 7A is an explanatory diagram showing a seventh embodiment of the present invention. A configuration of a network system illustrated in FIG. 7A is substantially the same as the network system shown in FIG. 3. In the seventh embodiment, the home agent M7A transfers the packet from the management node M10 to the mobile node M1.

In FIG. 7A, operations in (1) through (5) are the same as the operations in (1) through (5) in FIG. 3 explained in the third embodiment. With these operations, there comes to a status in which the binding “HoA-M2: CoA-M3” from the mobile node M1 becoming the spoofer behaving as the mobile node M2 is registered in the BC of the home agent M7A.

In this status, the management node M10 assigns permission of the packet transmission with respect to “HoA-M2” to the home agent M7A ((6) in FIG. 7A). Namely, the management node M10 sends, to the home agent M7A, a message requesting the permission that the management node M10 transmits the packet to the home-of-address “HoA-M2”.

Then, there comes to such a status that the home agent M7A transfers the packet addressed to “HoA-M2” from the management node M10 to a care-of-address CoA bound to “HoA-M2”.

Subsequently, the management node M10 transmits an arbitrary transmission packet addressed to “HoA-M2” to the home agent M7A ((7) in FIG. 7A).

The home agent M7A, upon receiving the transmission packet from the management node M10, refers to the binding “HoA-M2: CoA-M3” in the corresponding binding cache BC from the destination address “HoA-M2” of the transmission packet, and further binds the care-of-address “CoA-M5” of the management node M10 to the binding cache entry of “HoA-M2: CoA-M3” in the binding cache BC ((8) in FIG. 7A).

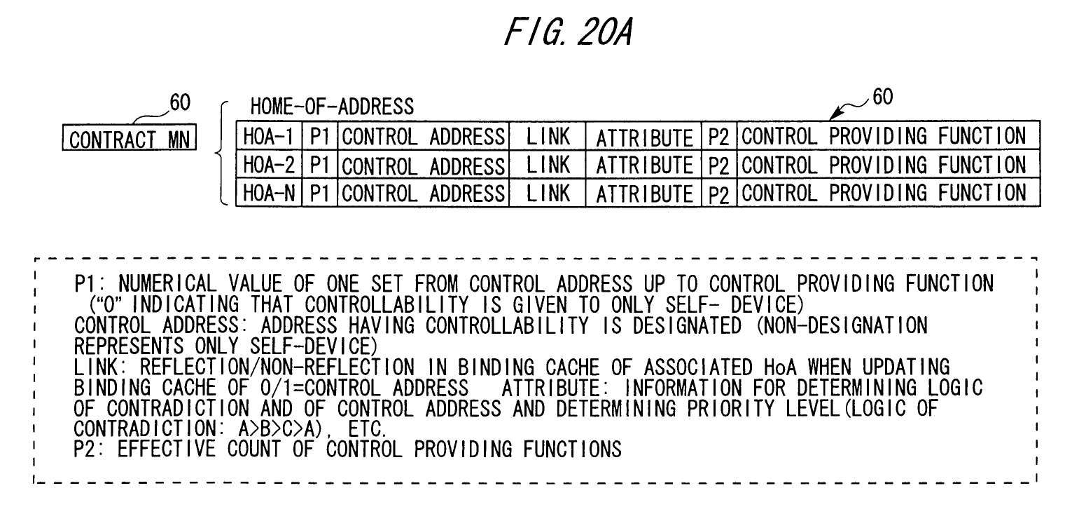

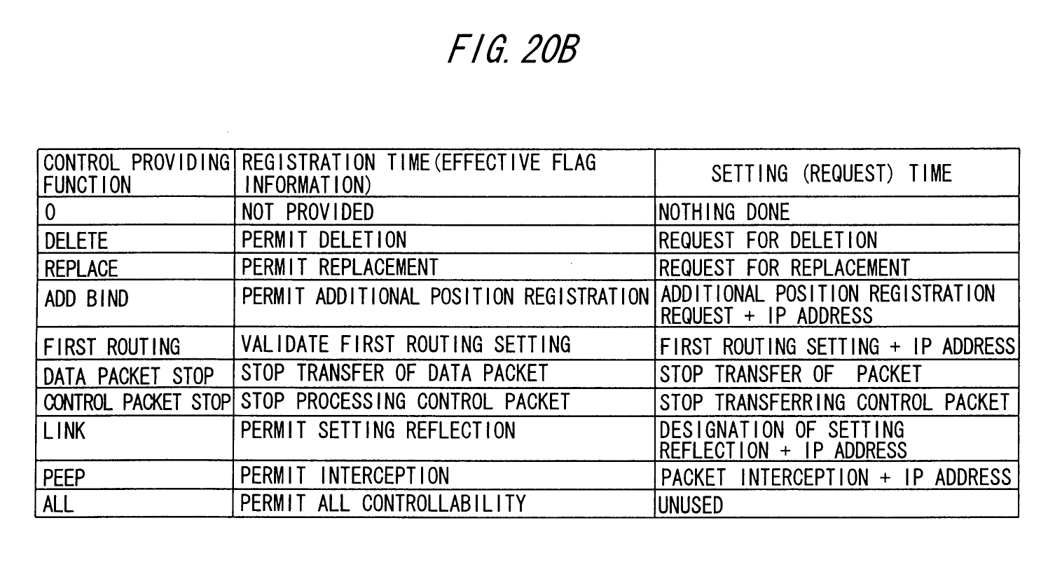

The care-of-address “CoA-M5” to be bound functions as a piece of controlled target information representing that the binding “HoA-M2: CoA-M3” is a control target of the management node M10, and the home agent M7A, when receiving the control information from the management node M10, executes the control based on the control information related to the binding cache entry of “HoA-M2: CoA-M3” to which this care-of-address “CoA-M5” is bound (registered). A specific content of this control can involve applying the content of the policy control shown in FIG. 20.

Subsequently, the home agent M7A translates the destination address of the transmission packet into “CoA-M3” and the source address into the address of the home agent M7A, and thereafter transmits the transmission packet (containing HoA-M2) to the mobile node M1 ((9) in FIG. 7A). Thus, the transmission packet from the management node M10 arrives at the mobile node M1. FIG. 7B shows an example of the packet transmitted to the mobile node M1 from the home agent M7A in (9) in FIG. 7A, wherein this packet contains the destination address “CoA-M3”, the home-of-address HoA and the data.

A further possible scheme is that the mobile node M1 sends a response (acknowledgment) packet to the transmission packet, and, when the home agent M7A receives the acknowledgment packet, the home agent M7A transfers the acknowledgment packet to the management node M10. In this case, the home agent M7A needs to know the address of the management node M10. For instance, the home agent M7A is notified of the address of the management node M10 in (6) in FIG. 7A.

According to the seventh embodiment, the arbitrary transmission packet can be transmitted to the unauthorized MN from the management node. At this time, the address of the home agent HA is set as the source address of the packet transmitted to the unauthorized MN, and hence, as viewed from the unauthorized MN, the reached packet can not be recognized as the packet from the management node.

The operation described above can be applied as follows. For example, such a case is assumed that the authorized user (the user A) does not hold the authorized MN (e.g., the mobile node M2) because of a loss, a theft, etc.

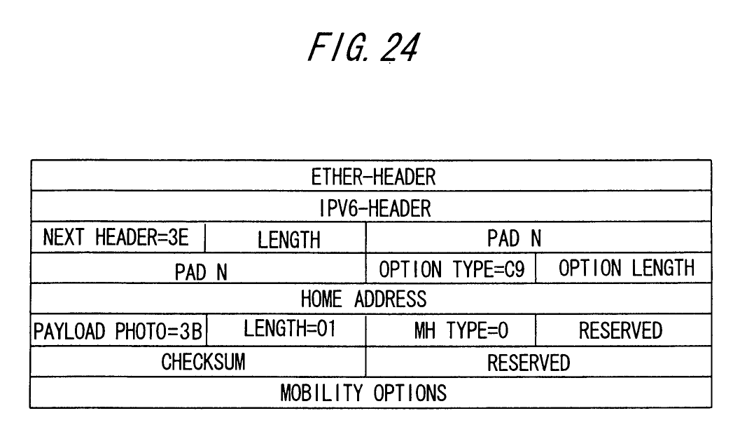

In this case, the administrator receives information of the loss and the theft from the user A, and operates the management node M10. According to this operation, the management node M10 sends, as a transmission packet, a binding refresh request message (BRR: see FIG. 24) requesting the MN for the position registration (the transmission of the BU) to the home agent M7A.

Then, the home agent M7A rewrites the source address of the BRR into the address of the home agent M7A itself, and thereafter sends the BRR message to each of the routers located within its own management range. Each router sends the BRR message to subnets subordinate to the router itself. At this time, if the mobile node M2 is located within the subnet of a certain router, this mobile node M2 generates the binding update BU as triggered by receiving the BRR message, and sends the BU to the-home agent M7A.

The home agent M7A, when receiving the binding update BU, updates the binding cache BC with the binding based on this BU. A present location of the mobile node M2 in the (foreign) network can be grasped from the care-of-address CoA of this binding.

Note that the home agent M7A, if unable to receive a response (BU) to the BRR message within a predetermined period of time, can also delete the BC corresponding to this BRR message.

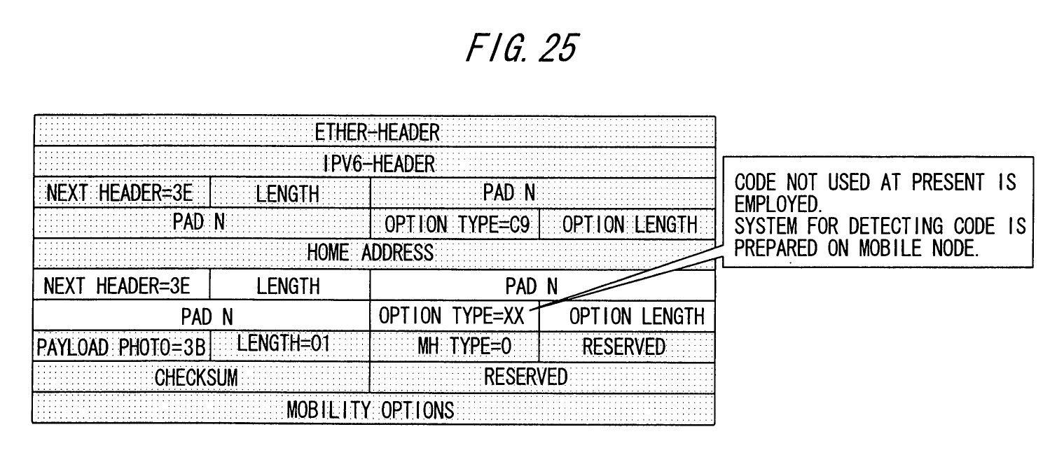

Moreover, the management node M10 can perform the following operation. The management node M10 generates a message (a stopping message: see FIG. 25) for stopping the operation of the mobile node M2, and sends this stopping message to the home agent M7A. The home agent M7A transfers, by the same operation as in the operational example described above, the stopping message to the mobile node M2.

The mobile node M2 is preinstalled with an application having a function of, upon accepting the stopping message, stopping the operation of the self-device or making a status of the self-device transit to an unusable status. With this function, the mobile node M2 transits to the stopping status (unusable status) as triggered by receiving the stopping message.

With this operation, it is possible to prevent the mobile node M3 from being abused by others. The stopping status or the unusable state, connoted herein, of the mobile node MN implies the stopping status or the unusable status of at least the communication function of the MN. The entire functions of the MN may also, however, be set in the stopping status or the unusable status.

Note that another available scheme is that the home agent M7A, just when receiving the BU from the mobile node MN, sends the stopping message explained above to this MN.

### Eighth Embodiment

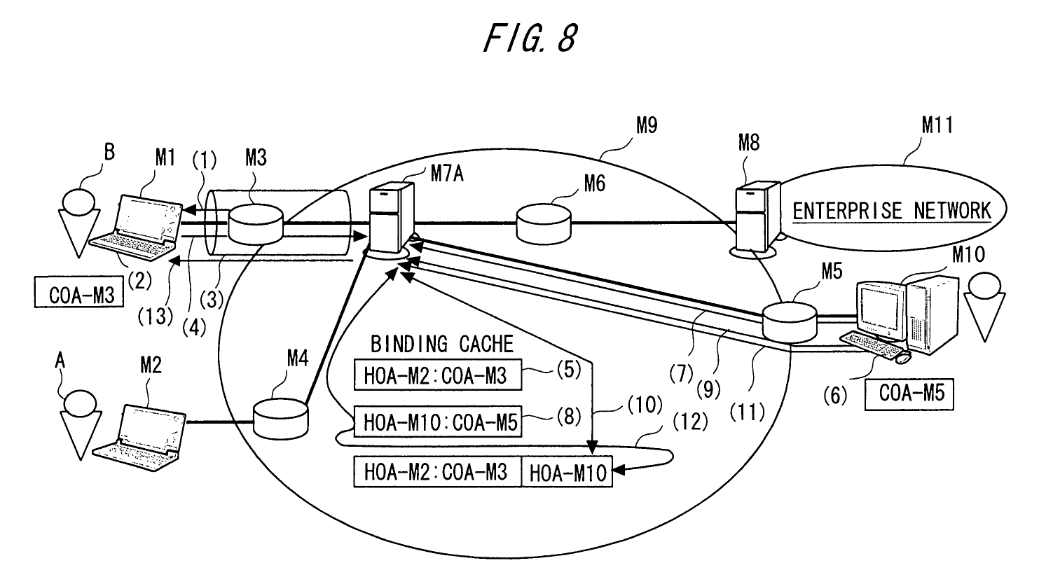

FIG. 8 is an explanatory diagram showing an eighth embodiment of the present invention. A configuration of a network system in the eighth embodiment is substantially the same as the network system in the seventh embodiment. The home agent M7A and the management node M10, however, operate differently.

In FIG. 8, operations in (1) through (5) in FIG. 8 are the same as those in the seventh embodiment. Through these operations, there occurs a status in which the unauthorized mobile node M1 registers the unauthorized binding “HoA-M2: CoA-M3” in the binding cache BC in the home agent M7A.

In this case, the management node M10, when transmitting the packet to the mobile node M1, operates as follows. To be specific, the management node M10 generates a self care-of-address “CoA-M5” ((6) in FIG. 8), and sends the binding update BU for notifying of the binding “HoA-M10: CoA-M5” to the home agent M7A ((7) in FIG. 8). Then, the home agent M7A registers this binding “HoA-M10: CoA-M5” in the binding cache BC ((8) in FIG. 8).

Next, the management node M10 sends a binding request message for binding the self home-of-address HOA to the binding related to “HoA-M2” in the BC to the home agent M7A ((9) in FIG. 8). Then, the home agent M7A binds, based on the binding request message, “HoA-M10” defined as the home-of-address HOA of the management node M10 to the binding cache entry of “HoA-M10: CoA-M3” related to HoA-M2 in the BC ((10) in FIG. 8). The home-of-address “HoA-M10” functions as the controlled target information explained in the seventh embodiment.

Thereafter, the management node M10 transmits the transmission packet addressed to the mobile node M1 to the home agent M7A ((11) in FIG. 8). This transmission packet contains the care-of-address “CoA-M5” of the management node M10.

The home agent M7A, when receiving the transmission packet from the management node M10, deduces “HoA-M10” from “CoA-M5” by referring to the binding cache BC, and further recognizes that “HoA-M10” is registered in (bound to) the binding cache entry of “HoA-M2: CoA-M3” ((12) in FIG. 8). From this recognition, the home agent M7A deems that the packet from HoA-M10 is permitted to be transferred to HoA-M2, then rewrites the source address of the transmission packet into the address of the home agent M7A itself, and thereafter transmits the transmission packet to the mobile node M1 ((13) in FIG. 8). Thus, the transmission packet can be transmitted to the mobile node M1.

### Ninth Embodiment

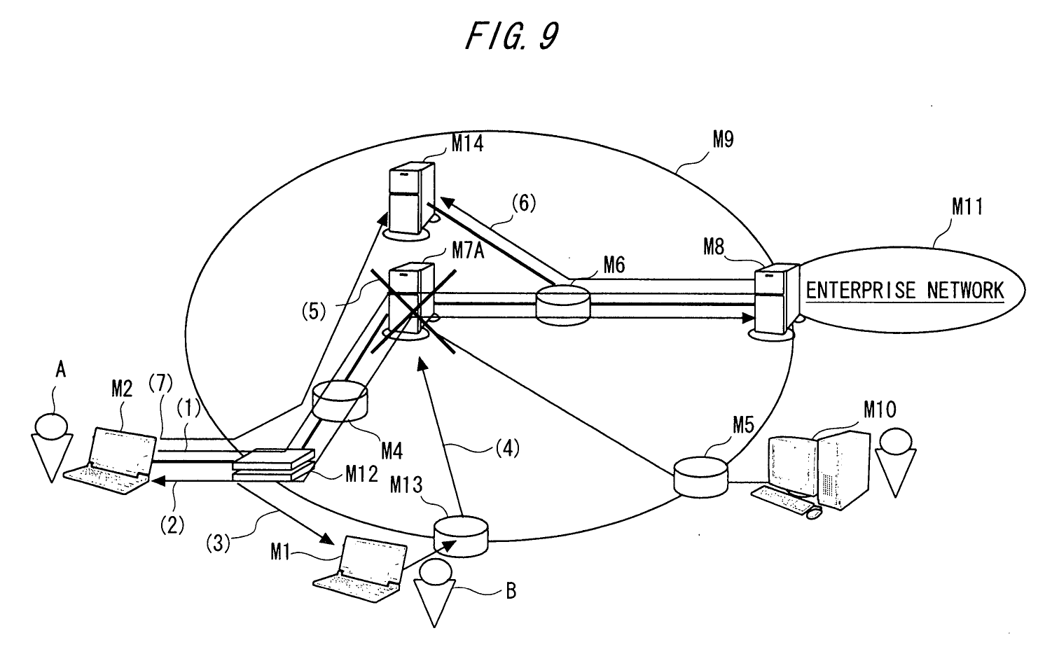

FIG. 9 is an explanatory diagram showing a ninth embodiment of the present invention. In FIG. 9, the mobile node M2 of the authorized user A accesses the router M4 via an access point M12 for a wireless LAN, and can register the BC related to the self home-of-address “HoA-M2” in the home agent M7A via the access point M12 and the router M4 ((1), (2) in FIG. 9).

The home agent M7A is constructed to make the position registration of CoA on the side of the gateway M8, and has a function (VPN (Virtual Private Network) gateway function) of establishing a VPN connection between the mobile node M2 and the gateway M8. Then, the mobile node M2 is accessible to the enterprise network M11 by VPN communications via the home agent M7A, the router M6 and the gateway M8.

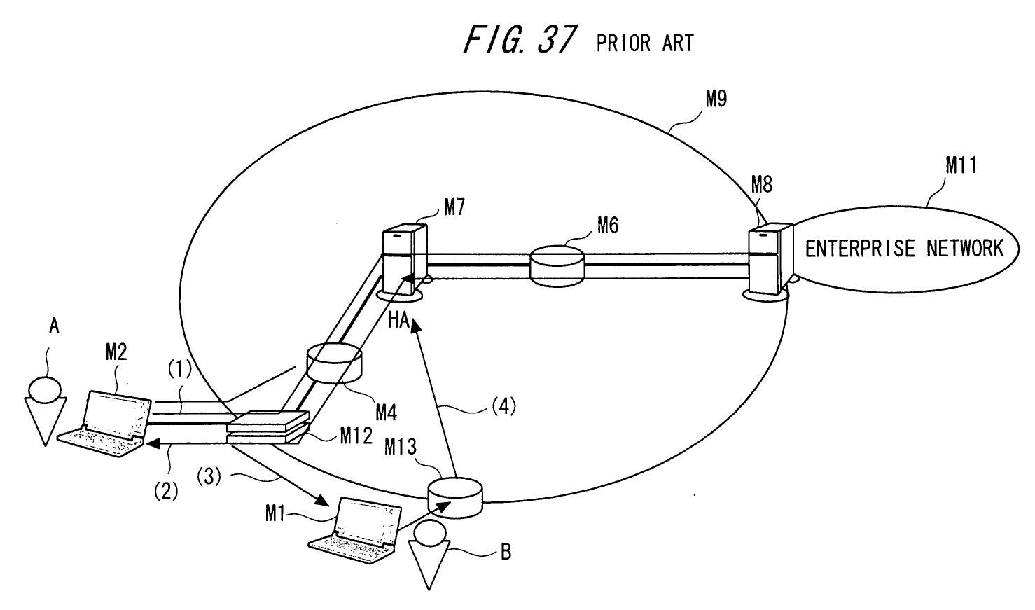

Assumed herein is a case in which the unauthorized user B unlawfully obtains the address of the home agent M7A via a wireless link between the mobile node M2 and the access point M12 ((3) in FIG. 9: this is the same as the interception shown in FIG. 37), and attacks at the home agent M7A through the router M13 ((4) in FIG. 9). Note that operations in (1) through (4) in FIG. 9 are the same as the operations in (1) through (4) in FIG. 7.

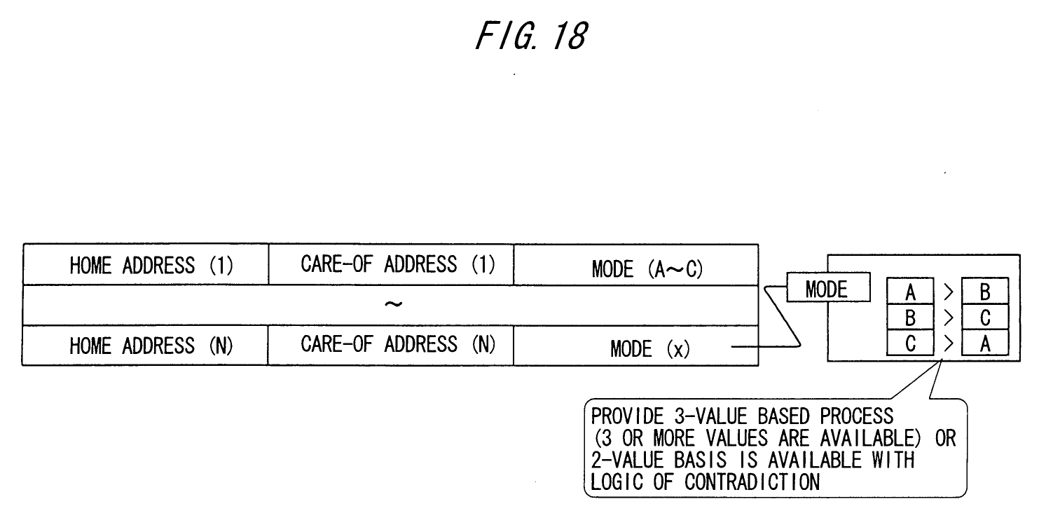

If the home agent M7A gets into stoppage of the operation (systemdown) due to the attack ((5) in FIG. 5), the mobile node M2 becomes unable to establish the VPN connection to the enterprise network M11. In this case, the gateway M8 provided at a boarder between the enterprise network M11 and the Internet M9, when detecting the systemdown of the home agent M7A, makes the position registration of the care-of-address CoA on the side of the gateway M8 in a home agent M14 serving as a proxy HA for the home agent M7A ((6) in FIG. 18).

On the other hand, the mobile node M2 knows the address of the home agent M14 serving as the proxy HA for the home agent M7A and, if unable to perform the communications due to the systemdown of the home agent M7A, registers a self-position in the home agent M14 ((7) in FIG. 18). Then, the home agent M14 actualizes the VPN connection between the mobile node M2 and the gateway M8. Thus, the mobile node M2, even if the home agent M7A gets into the systemdown by the unauthorized user B, can access the enterprise network M11.

A method by which the mobile node M2 selects the proxy HA is, for instance, a method of designating, as the proxy HA, a home agent HA of which the enterprise network Mil notified beforehand. Alternatively, an applicable scheme is that the mobile node M2, if the link to the home agent M7A is disconnected and if unable to establish the connection for a fixed period of time, searches for a home agent like the home agent M14 that temporarily actualizes the VPN, and makes the position registration in this home agent. In this case, the user may not take the trouble to be aware of switching the home agent. A required scheme is, however, that the proxy HA to be selected is the same on the side of the gateway M8 and on the side of the mobile node M2.

Moreover, the home agent M7A, when recovered, notifies the home agent M14 as the proxy HA of the recovery. For example, the home agent M7A, if recovered in a status of being registered with the information on the VON connection to the gateway M8, notifies the proxy HA of the address of the gateway M8. Then, the home agent M14 as the proxy HA detects the address of the gateway M8 as a duplicate address. Hereupon, the home agent M14 stops operating.

The mobile node M2, when detecting the stoppage (because of being unable to communicate) of the home agent M14, makes the position registration in the home agent M7A on the assumption that the home agent M7A has been recovered. With this operation, the mobile node M2 gets able to perform the VPN communications between the gateway M8 and the mobile node M2 itself via the home agent M7A.

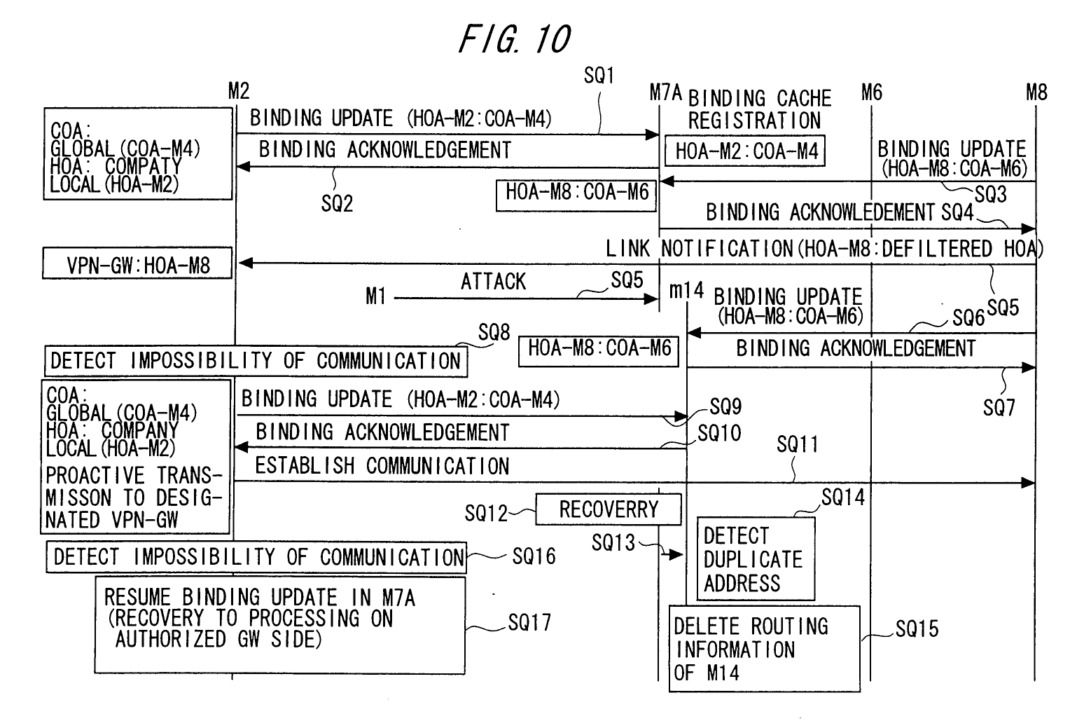

FIG. 10 is a sequence diagram showing an operational example in the ninth embodiment. As shown in FIG. 10, the mobile node M2 is constructed to use, as the home-of-address HoA, a local address “HoA-M2” in the enterprise network M11 and uses a global address as a care-of-address CoA.

The mobile node M2, in the case of making the position registration in the home agent M7A, generates the BU containing the home-of-address “HoA-M2” and a care-of-address (e.g., CoA-M4”) defined as an address of the router (in the foreign network) where the mobile node M2 itself is located at the present, and notifies the home agent M7A of this BU (SQ1).

Then, the home agent M7A registers, in the binding cache BC, the binding “HoA-M2: CoA-M4” of which the mobile node M2 has notified. Further, the home agent M7A, when making the registration in the BC, sends a position response (Binding Acknowledgement: BA) message to the mobile node M2 (SQ2).

On the other hand, the home agent M7A receives the BU containing “HoA-M8: CoA-M6” from the gateway M8 in the enterprise network M11 (SQ3). The home agent M7A registers, based on this BU, the binding “HoA-M8: CoA-M6” in the binding cache BC, and sends the BA message to the gateway M8 (SQ2). Thereafter, the home agent M7A transfers link notification (HoA-M8: defiltered HoA) sent from the gateway M8 to the mobile node M2 (SQ4). With this contrivance, the mobile node M2 can obtain “HoA-M8” as the address of the gateway M8, and can access the enterprise network M11 through the VPN communications via the home agent M7A.

Thereafter, if the mobile node M1 attacks at the home agent M7A (SQ5) with the result that the home agent M7A gets into the systemdown, the gateway M8, because of being unable to perform the communications via the home agent M7A, detects that the home agent M7A has got into the systemdown. A variety of existing methods can be applied as a detection method. Then, the gateway M8 sends the BU to the home agent M14 as the proxy HA (SQ6). With this operation, the binding on the side of the gateway M8 is registered in the binding cache BC of the home agent M14. The home agent M14 sends the binding acknowledgment (BA) message to the gateway M8 (SQ7).

On the other hand, the mobile node M2 detects that there is, for example, no response from the home agent M7A, thereby detecting that the communications can not be conducted due to the systemdown of the home agent M7A (SQ8). Then, the mobile node M2 sends the binding update BU to an address of the pre-designated home agent M14 (SQ9). Then, the home agent M14 registers the binding of the mobile node M2 in the BC and sends the BA message back to the mobile node M2 (SQ10). Through this operation, the VPN communications are established between the mobile node M2 and the gateway M8 via the home agent M14 (SQ11).

Thereafter, the home agent M7A, when recovered in a status of being registered with the information on the VPN communications between the gateway M8 and the mobile node M2 (SQ12), notifies the home agent M14 of the address of the gateway M8 (SQ13). The home agent M14 receives the notification from the home agent M7A, and, when detecting that the address of the gateway M8 is the duplicated address, deletes the routing information about the VPN communications between the gateway M8 and the mobile node M2, resulting in the down-status.

With this contrivance, the mobile node M2, upon detecting that the communications can not be done, re-executes the position registration (sends the BU to the home agent M7A. The VPN communications between the mobile node M2 and the gateway M8 via the home agent M7A are thereby recovered.

### Tenth Embodiment

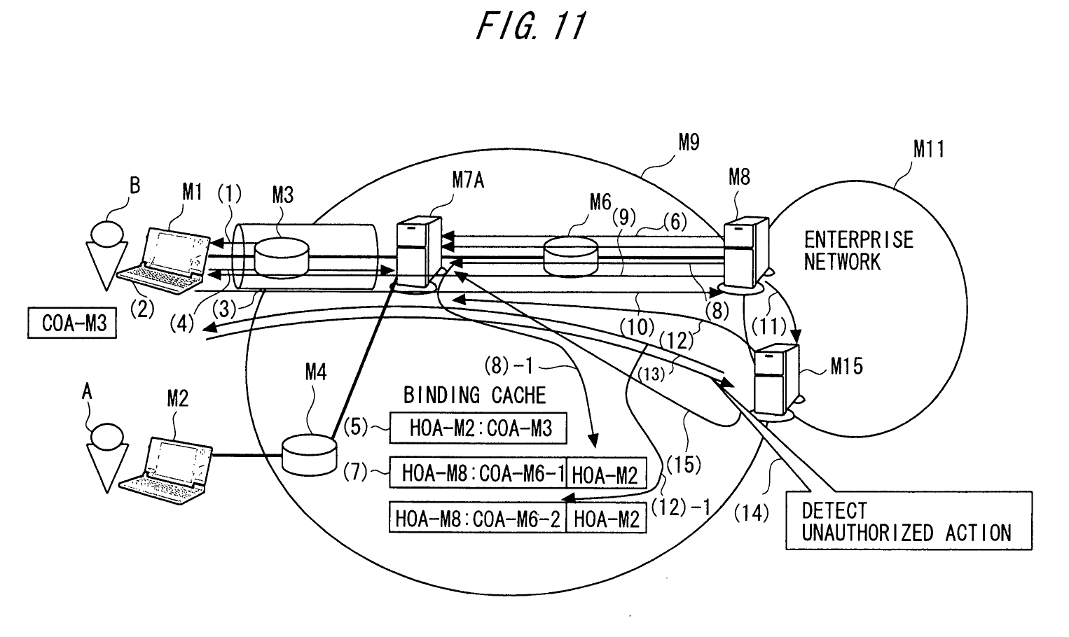

FIG. 11 is an explanatory diagram showing a tenth embodiment of the present invention. A configuration of a network system shown in FIG. 11 is substantially the same as the network system in the ninth embodiment. In FIG. 11, however, a gateway M15 serving as a secondary gateway (proxy gateway) for the gateway M8 is provided between the enterprise network M11 and the Internet M9. The gateway M15 is started up when a fault occurs in the gateway M8 and when a load increases over a predetermined value, and executes a node health check.

Explained as an operational example is a method for seamlessly changing the gateway on the enterprise side without switching over the operation of the mobile node if the fault or the load increase occurs in the gateway M8 on the enterprise side.

FIG. 11 illustrates that the physical gateway in the enterprise network is invisible (concealed) to the MN. The reason why so is that the gateway on the enterprise side is dynamically fluctuated (changed). Accordingly, on the side of the mobile node, the address of the home agent HA (which is the home agent M7A in FIG. 11) substantially becomes an address of the gateway.

FIG. 11 shows not only a method of dynamically changing the gateway but also a method by which the gateway, as triggered by the change of the gateway, performs the node health check of the subordinate mobile node MN and thus checks whether this MN is the regular (authorized) MN or not.

An assumption in FIG. 11 is that the unauthorized mobile node M1 becomes the spoofer behaving as the regular mobile node M2 (having the home-of-address “HoA-M2”) and makes the unauthorized position registration. By the same operations as those in (1) through (5) in FIG. 3, in the home agent M7A, the binding “HoA-M2: CoA-M3” sent from the mobile node M1 is registered in the binding cache BC (refer to (1) trough (5) in FIG. 11).

On the other hand, the gateway M8 in the enterprise network M11 makes the position registration in the home agent M7A ((6) in FIG. 11). The binding “HoA-M8: CoA-M6-1” related to the gateway M8 is thereby registered in the BC ((7) in FIG. 11).

Thereafter, the gateway M8 sends, as filtering designation for “HoA-M2”, a message purporting permission of the access to this home-of-address “HoA-M2” ((8) in FIG. 11). Then, the home agent M7A binds, based on this message, “HoA-M2” to the binding cache entry related to “HoA-M8” in the BC ((8)-1 in FIG. 11).

Subsequently, the gateway M8 sends the information purporting the access permission to “HoA-M2”, i.e., the mobile node M1 ((9) in FIG. 11). With this operation, the mobile node M1 transmits the packet addressed to the gateway M8 to the home agent M7A as the destination.

The home agent M7A, when recognizing the source address “HoA-M2” of this packet, refers to the BC table wherein “HoA-M2” is bound to the BC entry related to “HoA-M8”, therefore encapsulates this packet, and transmits the encapsulated packet to “HoA-M8”, i.e., the gateway M8. Thus, the home agent M7A executes the VPN proxy process on the side of the gateway M8.

By the way, the user B of the mobile node M1, when the access to the gateway M8 is permitted, can attack at the gateway M8. If the mobile node attacks at the gateway M8 ((11) in FIG. 11) with the result that the load of the gateway M8 rises, the gateway M8 shifts the process to the proxy gateway M15 ((11) in FIG. 11). This shift is conducted in such a way that the gateway M8 commands the gateway M15 to shift the process.

The gateway M15, when receiving the shift command from the gateway M8, sends the BU to the home agent M7A and makes the position registration ((12) in FIG. 11). At this time, the gateway M15 uses the home-of-address “HoA-M8” of the gateway M8 as the home-of-address.

The home agent M7A registers, in the binding cache BC, the binding “HoA-M8: CoA-M6-2” contained in the BU sent from the gateway M15, and binds “HoA-M2” bound to the already-registered binding cache entry related to “HoA-M8” to the binding cache entry of “HoA-M8: CoA-M6-2” ((12)-1 in FIG. 11). With this contrivance, the mobile node M1 comes to an accessible status to the enterprise network M11 via the gateway M15 as the proxy for the gateway M8.

Thus, if the fault and the load increase occur in the default (primary) gateway, the process is dynamically shifted to the secondary gateway without any switching operation by the MN. Note that the gateway M15 can be also configured to monitor the gateway M8 and to, if the gateway M8 gets into the systemdown, operate as the proxy for the gateway M8.

The gateway M15, when making the position registration in the home agent M7A, transmits a test signal of the node health check to the MN (which is herein the mobile node M1) subordinate to the home agent M7A ((13) in FIG. 11).

The node health check test signal can be actualized by adding an extension to, e.g., Ping command. Then, a scheme is that the regular (authorized) MN (e.g., the mobile node M2) accessible to the enterprise network M11 sends a special item of information (code etc) known by only the regular mobile node MN in response to the node health check test signal back to the gateway M15, or any response to the test signal is not sent back. Further, in response to the health check test signal, if the MN other than the regular MN receives this test signal, an item of information other than the special information is sent back, or an unnecessary response is sent back. Herein, an assumption about the scheme is that the regular MN sends back the special information in response to the health check test signal.

The mobile node M1 is not the regular MN and therefore, when receiving the health check test signal, sends back the information other than the special information. The gateway M15, when receiving the information other than the special information, recognizes that the mobile node M1 is the unauthorized MN ((14) in FIG. 11).

Then, the gateway M15 executes the filtering setting for the packet sent from “HoA-M2” of the mobile node M1 in the home agent M7A ((15) in FIG. 11). For example, the gateway M15 can control the home agent M7A so that the home agent M7A deletes the BC entry of “HoA-M2”, discards the packet from “HoA-M2” and rejects the position registration from “HoA-M2”. Owing to this control, the unauthorized mobile node M1 gets unable to connect to the home agent M7A and therefore gets into the impossible-of-communication status.

It should be noted that the gateways M8 and M15 can be configured to be, with their load balance being taken into consideration, if one load becomes greater than the other, switched over dynamically from one gateway to the other.

FIG. 12 is a sequence diagram showing an operational example in the tenth embodiment. In FIG. 12, when the mobile node M1 makes the position registration (SQ21), the home agent M7A registers the binding “HoA-M2: CoA-M4” in the BC, and sends the binding acknowledgment (BA) back to the mobile node M1 (SQ22).

On the other hand, the gateway M8 makes the position registration (Binding Update) (SQ23), the binding “HoA-M8: CoA-M6-1” is registered in the binding cache BC of the home agent M7A, and the binding acknowledgement is sent back to the gateway M8 (SQ24). Then, the link notification representing the access permission of the mobile node M1 is given to the mobile node M1 from the gateway M8 via the home agent M7A (SQ25).

With this operation, the mobile node M1 attacks at the gateway M8 (SQ26), and the gateway M15 is, when the load of the gateway M8 rises, started up and makes the position registration (BU) in the home agent M7A (SQ27). The BC entry (HoA-M8: CoA-M6-2) of the gateway M15 is registered, and the binding acknowledgment is sent back to the gateway M15 (SQ29).

Then, the gateway M15 transmits the health check test signal to the mobile node M1 (SQ29). The mobile node M1 responds to this health check test signal (SQ30), and, if this response is not valid, the gateway M15 detects that the mobile node M1 is the unauthorized node (SQ31).

Then, the gateway M15 sends, to the home agent M7A, the BU that requires setting a lifetime of the home-of-address “HoA-M8” to “0” (the router advertisement is invalidated) and deleting the BC entry of “HoA-M2” (SQ32). The home agent M7A, based on this BU, sets the lifetime of “HoA-M8” to “0” and deletes the BC entry concerned, at which time the mobile node M1 comes to the impossible-of-communication status with the gateway. Therefore, it is detected that the communications can not be performed by the mobile node M1 (SQ33).

The configurations and the functions in the first through tenth embodiments discussed above can be properly combined as the necessity may arise.

### Example of Configuration of Mobility Support Apparatus

Given next is an example of the configuration of the mobility support apparatus (HA) for actualizing the operations explained in the embodiments discussed above. FIG. 13 is a block diagram showing the example of the configuration of the home agent HA. In FIG. 13, a HA 10 is a home agent (HA) applicable as the home agent M7A described above. The HA 10 is constructed of, e.g., a router and a layer-3 switch device.

The HA 10 includes, as hardware components, a control device (a CPU, a main memory (a RAM etc), an auxiliary memory (a RAM, a ROM, a hard disc, etc), an input/output unit, a device driver, and a communication control device (a network interface device etc), wherein the CPU structuring the control device executes a variety of programs (operating system (OS) and a variety of applications) stored in the auxiliary device etc, thereby functioning as the device having a plurality of blocks (functions) as shown in FIG. 13.

Namely, the HA 10 functions as the device including at least one network interface 13 having a reception processing unit 11 and a transmission processing unit 12 (FIG. 13 exemplifies only one network interface: corresponding to communication unit), a packet identifying unit 14, a router advertisement message processing unit 15, a mobile IP message processing unit 16 (corresponding to update processing unit, transfer destination setting unit, transmission enabled status setting unit, relay processing unit, registering unit and control unit), a policy table 17 (corresponding to a storage unit), a packet disassembly unit 18, an application 19, a user interface 20, a packet assembly unit 21, a timer 22 (corresponding to time measuring unit) and a transfer destination switching function 23 (corresponding to transfer control unit).

The reception processing unit 11 receives the packet from the network and transfers the packet to the packet identifying unit 14. The transmission processing unit 12 sends the packet received from the transfer destination switching function 23 to a transfer destination via the network.

The packet identifying unit 14 analyzes a content of the packet received from the reception processing unit 11 and identifies a packet type. The packet identifying unit 14, for this analysis, refers to the policy table 17 as the necessity may arise.

The packet identifying unit 14, if the packet contains the router advertisement message, sends this router advertisement message to the router advertisement message processing unit 15. Further, the packet identifying unit 14, if the packet contains a mobile IP message (BU etc) or the binding acknowledgment BA, sends this packet to the mobile IP message processing unit 16. Furthermore, the packet identifying unit 14, when identifying the packet with an application data packet, sends this packet to the packet disassembly unit 18.

The mobile IP message processing unit 16 receives the mobile IP message (a control message of the HA) such as the BU from the packet identifying unit 14, and executes a variety of processes according to the mobile IP message. For example, the mobile IP message processing unit 16 manages (such as adding/updating/deleting the binding), based on the BU, the BC table (corresponding to a storage unit) provided in, e.g., the policy table 17.

Further, the mobile IP message processing unit 16 executes the status setting, the status judgment, and the creation of the message based on the status setting and the status judgment in association with, for instance, the deletion of the unauthorized biding by updating the BC on the basis of the priority level (the first through fifth embodiments), the designation of the routing destination and the cancellation of the designation thereof (the sixth embodiment), the transfer of the packet to the arbitrary home-of-address HoA (MN) (the seventh and eighth embodiments), the switchover control of the home agent HA (the ninth embodiment) and the control corresponding to the switchover of the gateway (GW) (the tenth embodiment). The mobile IP message processing unit 16 executes the status setting and the status judgment by referring to the various items of information containing the BC stored in the policy table 17.

Moreover, the mobile IP message processing unit 16, in the case of creating a transmission message based on the mobile IP message, sends this transmission message to the packet assembly unit 21.

The mobile IP message processing unit 16 registers and refers to the policy table 17. The policy table 17 is stored with the information (a table 60 shown in FIG. 20) about setting the policy used for the mobile IP message processing unit 16 to carry out the operations described in the first through tenth embodiments. Further, the policy table 17 has, as described above, the BCs (BC entries) (the BC table (see FIGS. 16-19)) with respect to the respective home-of-addresses HoAs.

The timer 22 measures a predetermined period of time as triggered by registering the binding having the highest priority level in the binding cache BC in order to actualize the operation in the fourth embodiment. The timer 22 is controlled by the management function of the policy table 17, and, when the timer 22 gets into timeout, the management function changes the priority level set in the BC to a lower-order level.

The packet disassembly unit 18 extracts a data part (data field) from one or more application data packets received from the packet identifying unit 14, then generates the reception data, and transfers the data to the application 19.

The application 19 executes a process for the reception data on the basis of various items of information (data and commands, etc) inputted from the user interface 20. Further, the application 19 outputs information (data etc) showing a result of the process for the reception data to the user interface 20, and transfers the transmission data acquired by the process for the reception data to the packet assembly unit 21.

The packet assembly unit 21 assembles one or more transmission packets each stored with the transmission data and the transmission message, and transfers the assembled packets to the transfer destination switching function 23.

The transfer destination switching function 23 rewrites an address of the transfer destination of the transmission packet. For example, the transfer destination switching function 23 rewrites the destination address of the transmission packet into a designated address obtained from the policy table 17. Further, the transfer destination switching function 23, as the necessity may arise, rewrites the destination address of the transmission packet into the designated address (a first routing address) and rewrites a source address into an address of the home agent HA 30. The transmission packet is sent to the transmission processing unit 12 and forwarded to the network.

### Example of Configuration of Mobile Node

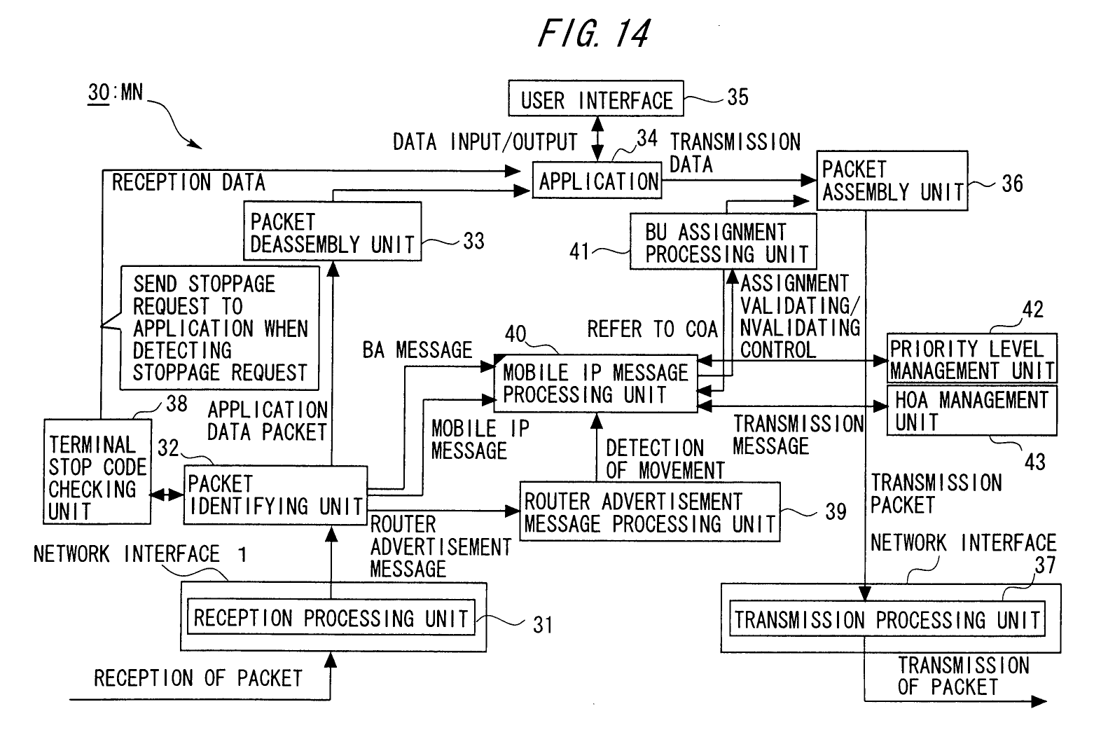

Next, an example of the configuration of the mobile node (MN) for actualizing the operations explained in the embodiments discussed above, will be described. FIG. 14 is a block diagram showing the example of the configuration of the MN. In FIG. 14, the MN 30 is a home agent (HA) applicable as the mobile node M2. The MN 30 is constructed of a computer having portability such as a notebook type personal computer and a PDA (Personal Digital Assistant).

The MN 30 includes, as hardware components, a control device (a CPU, a main memory (a RAM etc), an auxiliary memory (a RAM, a ROM, a hard disc, etc), an input/output unit, a device driver, and a communication control device (a network interface device etc), wherein the CPU structuring the control device executes a variety of programs (operating system (OS) and a variety of applications) stored in the auxiliary device etc, thereby functioning as the device having a plurality of blocks (functions) as shown in FIG. 14.

The MN 30 functions as a device including a reception processing unit 31, a packet identifying unit 32, an application 34, a user interface 35, a packet assembly unit 36, a transmission processing unit 37, a node stop code check unit 38, a router advertisement message processing unit 39, a mobile IP message processing unit 40, a BU assignment processing unit 41, a storage unit 42 for information representing whether there is a priority message or not, and a position registration (binding update) priority process list 43.

The reception processing unit 31 configuring part of the network interface receives the packet from the network and sends the packet to the packet identifying unit 32.

The packet identifying unit 32 analyzes a content of the packet and, if the packet contains the router advertisement message, sends this router advertisement message to the router advertisement message processing unit 39. Further, the packet identifying unit 32, if the packet contains the mobile IP message or the binding acknowledgement (BA) message, sends the message to the mobile IP message processing unit 40. Moreover, if the packet is the application data packet, sends this packet to the packet disassembly unit 33.

The packet disassembly unit 33 executes a process of dissembling the packet, then reassembles the reception data and sends the reassembled packet to the application 34.

The application 34 executes, according to the necessity, a variety of processes for the reception data on the basis of the information (data and commands) inputted from the user interface 35, then outputs information (data etc) showing results of these processes to the user interface 35, and sends the transmission data generated as the results of these processes for the reception data to the packet assembly unit 36.

The packet assembly unit 36 generates one or more transmission packets each containing the transmission data or the BU (with the priority level designated/non-designated) given from the BU assignment processing unit 41, and sends the packets to the transmission processing unit 37.

The transmission processing unit 37 configuring part of the network interface forwards the transmission packets to the network.

The router advertisement message processing unit 39 checks a router address (CoA) from the router advertisement message sent from the router, then detects, if the care-of-address (CoA) changes, the movement of the MN and notifies the mobile IP message processing unit 40 of the MN's movement.

The mobile IP message processing unit 40, when receiving the notification of the movement from the router advertisement message processing unit 39, generates a BU message and transfers this message to the BU assignment processing unit 41. Further, the mobile IP message processing unit 40, when receiving the BRR (Binding Refresh Request) message as the mobile IP message, also generates the BU message.

The BU message generated by the mobile IP message processing unit 40 is transferred to the BU assignment processing unit 41. Further, the mobile IP message processing unit 40 controls validity/invalidity for the priority level assigning process of the BU assignment processing unit 41.

If any priority level is not assigned to the binding update (BU), the process of the BU assignment processing unit 41 is invalidated, then, whereas if the priority level is assigned, the message processing unit 40 notifies of a should-be-assigned priority level, and the BU message assigned the priority level from the BU assignment processing unit 41 is transferred to the packet assembly unit 36.

The priority level management unit 42 manages pieces of information on the priority levels that can be designated by the MN and on the priority level designated last time. The information managed by the priority level management unit 42 is referred to by the message processing unit 40, and the message processing unit 40 acquires a should-be-designated priority level and notifies the BU assignment processing unit 41 of this priority level.

The HoA management unit 43 manages a plurality of HoAs assigned to the MNs and the information related to these HoAs (which is, e.g., the information showing the priority levels (a relationship in their superiority)). The message processing unit 40 determines a should-be-used HoA in a way that refers to the information managed by the HoA management unit 43, and generates the BU message containing this determined HoA.

The node stop code check unit 38 detects a stop message reaching the packet identifying unit 32 and notifies the application 34 of this packet. Namely, the node stop code check unit 38 checks a code set in a predetermined position (field) of the packet inputted to the packet identifying unit 32 and, if this code is a code stop code, notifies the application 34 of this purport. Then, the application 34 stops a status of the MN 30 or sets the MN 30 in an unusable status.

### Example of Configuration of Management Node

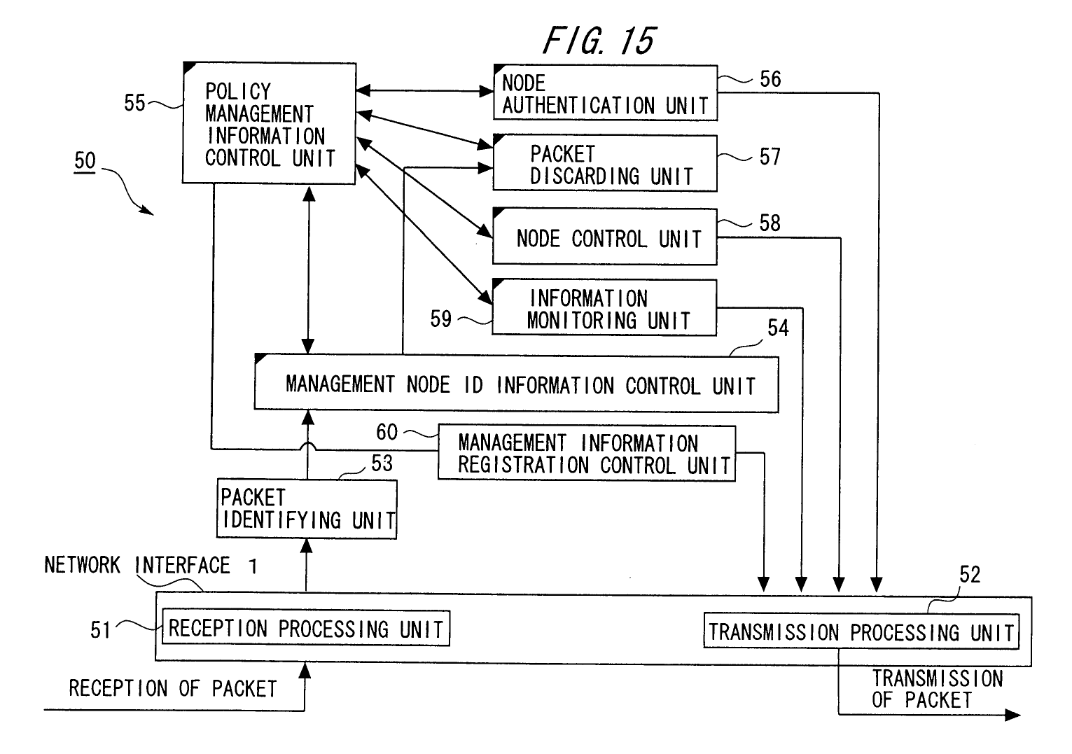

Given next is an explanation of an example of a configuration of the management node for actualizing the operations described in the embodiments discussed above. FIG. 15 is a block diagram showing the example of the configuration of the management node. In FIG. 15, the MN 30 is a home agent (HA) applicable as the mobile node M2. The MN 30 is constructed of an information processing device such as a personal computer and a workstation.

The management node 50 includes, as hardware components, a control device (a CPU, a main memory (a RAM etc), an auxiliary memory (a RAM, a ROM, a hard disc, etc), an input/output unit, a device driver, and a communication control device (a network interface device etc), wherein the CPU structuring the control device executes a variety of programs (operating system (OS) and a variety of applications) stored in the auxiliary device etc, thereby functioning as the device having a plurality of blocks (functions) as shown in FIG. 15.

In FIG. 15, the management node 50 functions as a device including a reception processing unit 51, a transmission processing unit 52, a packet identifying unit 53, a management node ID information control unit 54, a policy management information storage unit 55, a node authentication unit 56, a packet discarding unit 57, a node control unit 58, an information monitoring unit 59 and a management information registration control unit 60.

The reception processing unit 51 receives the packet from the network. The transmission processing unit 52 transmits the packet to the network. The packet identifying unit 53 identifies a packet type and transfers a predetermined type of packet to the management node ID information control unit 54.

The management node ID information control unit 54 manages a management target unique node ID information of the management node 50, collates the node ID contained in the packet sent from the packet identifying unit 53 with the managed node IDs, then transfers, if coincident with any one of the managed node IDs, this packet to the policy management information storage unit 55, and, whereas if not, transfers the packet to the packet discarding unit 57.

The policy management information storage unit 55 manages the policy and controls, based on the policy, the node authentication unit 56, the packet discarding unit 57, the node control unit 58, the information monitoring unit 59 and the management information registration control unit 60.

The node authentication unit 56 judges, according to an instruction given from the control unit 55, when the mobile node makes a position registration (binding update) delete request etc, whether the user of this mobile node is a regular contract user or not by use of SSL (Secure Sockets Layer) etc.

The packet discarding unit 57 discards an invalid packet. For instance, the packet discarding unit 57 receives a request packet from the mobile node having the node ID information that is not managed by the management node 50, and discards this request packet. An available scheme is, it should be noted, that the packet identifying unit 53 judges by referring the node ID information of the packet whether or not the node ID information is the management target node ID information, and, if not the management target node ID information, discards this packet.

The node control unit 58 generates, based on an instruction given from the control unit 55, a message (transmission packet) for the mobile node, and this message is transmitted from the transmission processing unit 52. For example, the node control unit 58 can generate and transmit a message such as the BRR message and the stop message as explained in the seventh embodiment.

The information monitoring unit 59 peeps (peeping) the packet etc sent from the MN and then transferred from the HA as explained in the sixth embodiment. Further, the information monitoring unit 59 can also transfer the peeped packet toward the original destination.

The management information registration control unit 60 executes a process for setting a policy related to the management target mobile node. To be specific, the management information registration control unit 60, based on the policy managed by the policy management information storage unit 55, generates a control message for setting the policy in the HA and sends the control message toward the HA from the transmission processing unit 52.

### Example of Table Structure

Next, the example of the table structure applicable to the embodiments of the present invention discussed above, will be explained. FIG. 16 is a diagram showing a data structure of the BC table that is applicable to the first and second embodiments. The BC table is generated on the storage device held by the home agent HA and structured of one or more entries prepared for every binding (HoA and CoA). Each entry includes a field stored with the binding and a field representing the priority level (Priority) assigned to the binding. The priority level storage field is a newly prepared field. The priority level registered in this field is referred to for a comparison with the priority level contained in the binding update BU.

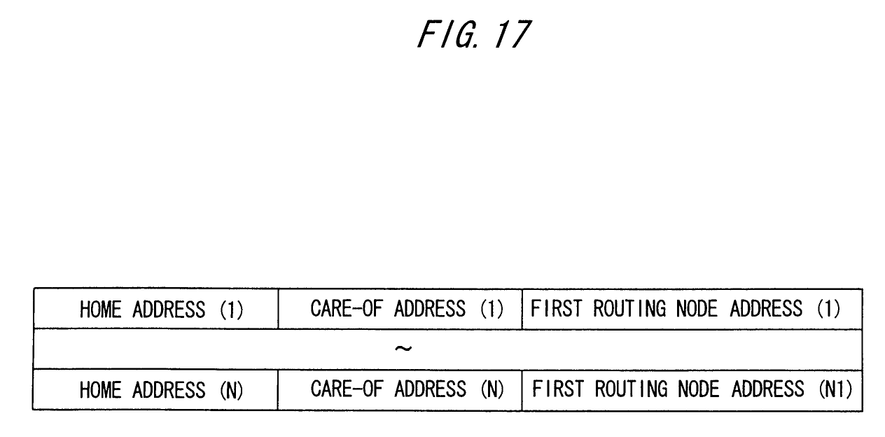

FIG. 17 is a diagram showing an example of a data structure of the BC table that is applicable to the sixth embodiment. The BC table shown in FIG. 17 is generated on the storage device held by the HA and includes a plurality of entries prepared for every binding. Each entry includes a field stored with the binding (HoA and CoA) and a field stored with a designated address (First Routing Address) used as a destination address of the packet. A value of the designated address is referred to when the HA transfers the packet, wherein the packet is transferred as it is if the value of the designated address is “0” (non-designation), then, whereas if not, this designated address is set to the destination address of the packet, and the packet is transferred to this destination address.

FIG. 18 shows an example of a data structure of the BC table that is applicable to the fifth embodiment. The BC table shown in FIG. 18 is generated on the storage device held by the HA and structured of one or more entries prepared for every binding. Each entry includes a field stored with the binding (HoA and CoA) and a field stored with a value (MODE value) representing superiority or inferiority of one binding (HoA: CoA) to other bindings (HoA: CoA). It is preferable that the superiority relationship between the MODE values be, for instance, a 3-value based relationship. For example, if the MODE values take A, B and C, there is established a relationship such as A>B>C>A. Further, the MODE values may take two values (e.g., A and B), wherein the value registered later in the BC table is set superior to the value registered earlier.

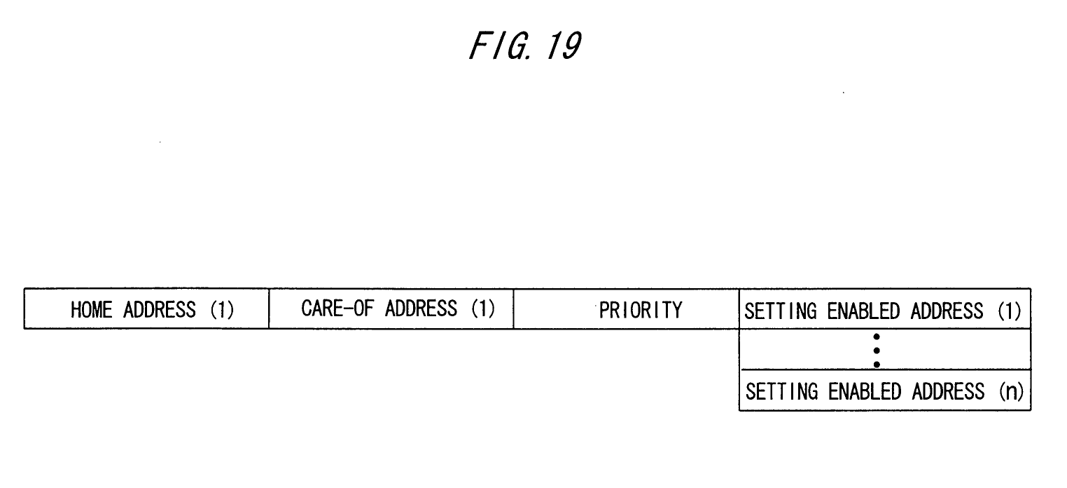

FIG. 19 is a diagram showing an example of the BC table, wherein an address for setting the priority level is assigned. The BC table shown in FIG. 19 is generated on the storage device held by the HA and includes a field stored with the binding, a field stored with the priority level with respect to the binding and a field stored with one or more setting enabled addresses each representing an address of the node (such as the MN and the management node) capable of setting the priority level with respect to the binding.

The HA, when receiving the BU containing the designated priority level, specifies the associated BC (BC entry) from the home-of-address HoA contained in this BU. At this time, the HA judges which setting enabled address the source address of the BU corresponds to, then executes the superiority judging process about the priority level as explained in the first embodiment if the source address corresponds thereto, and ignores (e.g., discards) this BU whereas if not. With this scheme, it is possible to prevent, in such a case that the nodes having the BC update authority are limited, the BC from being updated with the BU sent from the unauthorized node.

FIG. 20A is a diagram showing an example of a structure of the table employed for an associative registration process of the plurality of HoAs. FIG. 20B is an explanatory diagram showing of a control providing function stored in a table 60.

In FIG. 20A, the table is prepared for every contract MN. The table 60 has a plurality of entries for the plurality of HoAs set for the contract MN (when the contract MN has one HoA, one entry is provided). Each entry has fields that retain a HoA name, a “P1” value, a control address, a link, an attribute, a “P2” value and a control providing function, respectively. The table 60 is provided in, for instance, the policy table 17 shown in FIG. 13 and within the policy management information storage unit 55 illustrated in FIG. 15.

In the table 60 shown in FIG. 20A, a numerical value of one set from the control address down to the control providing function is set in the “P1” field. If the “P1” value is “0”, however, the controllability is given to only the self-device (the HA or the management node). An address having the controllability is designated in the “control address” field. If no address is designated in the control address, it follows the controllability is held by only the self-device. Set in the link field (Link) is a value (e.g., “0”) representing, when updating the BC (BC entry) associated with the control address, that the care-of-address CoA of the update-related binding is not reflected in other BCs (BC entries) each containing the home-of-address HoA of this binding, or is a value (e.g., “1”) representing that the CoA is reflected therein. Set in the attribute field is information (e.g., A>B>C>A) for determining a logic of contradiction for the control address and information showing a method of determining the priority level for the binding. A valid count of the control providing functions is set as the “P2” value. The control providing function involve preparing, as shown in FIG. 20B, delete (DELETE), replacement (REPLACE), additional position registration (additional binding update) (ADD BIND), first routing setting (FIRST ROUTING), a stop of data packet transfer (DATA PACKET STOP), a stop of control packet process (CONTROL PACKET STOP), reflection of setting (LINK), permission of interception (PEEP) and so on.

### Example of Message Format

Next, an example of a message format applicable to the embodiments discussed above will be explained. FIG. 21A is a diagram showing the example of the format of the BU message in which the priority level is designated. FIG. 21B is an explanatory diagram showing in detail a header field of “priority process registration” shown in FIG. 21A. This BU message can be applied to the first and second embodiments. As illustrated in FIG. 21A, the BU message is provided afresh with the header field of the “priority process registration” that is stored with indicated level information, wherein the priority level is set in this field (FIG. 21B). Further, an unused code is employed as an option type (Option Type) representing the “priority process registration”.

FIG. 22 is a diagram showing an example of the BU message in which the priority level is defined by a length of the message. This BU message can be applied to the first and second embodiments. As shown in FIG. 22, the message can be also structured so that the mobile node MN inserts a predetermined number of fixed type headers between a “Home Address” field and a “Payload Photo” field, and the priority level assigned to the BU by the HA is deduced from the number of these headers (header count). For example, such a definition can be given that as the header count becomes larger (smaller), the priority level rises (lowers).

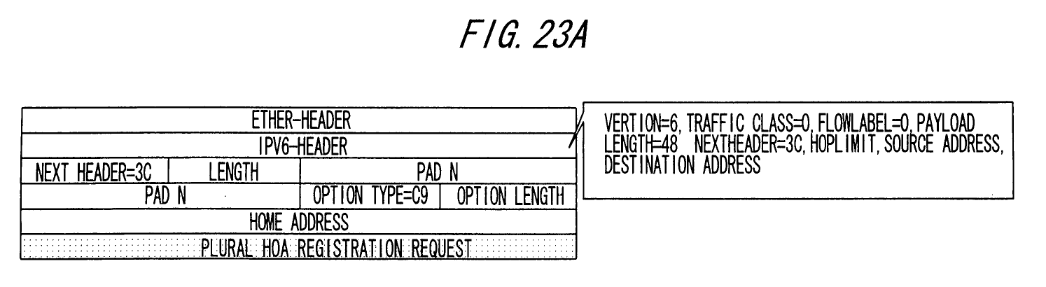

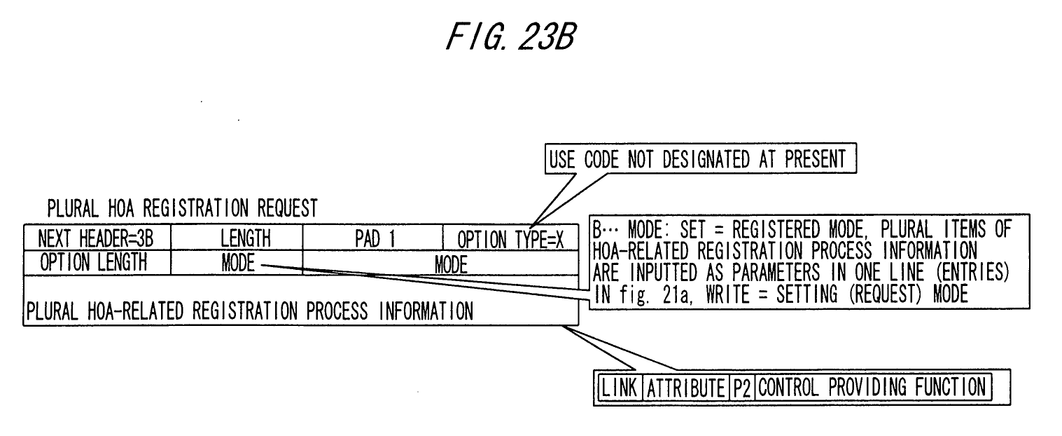

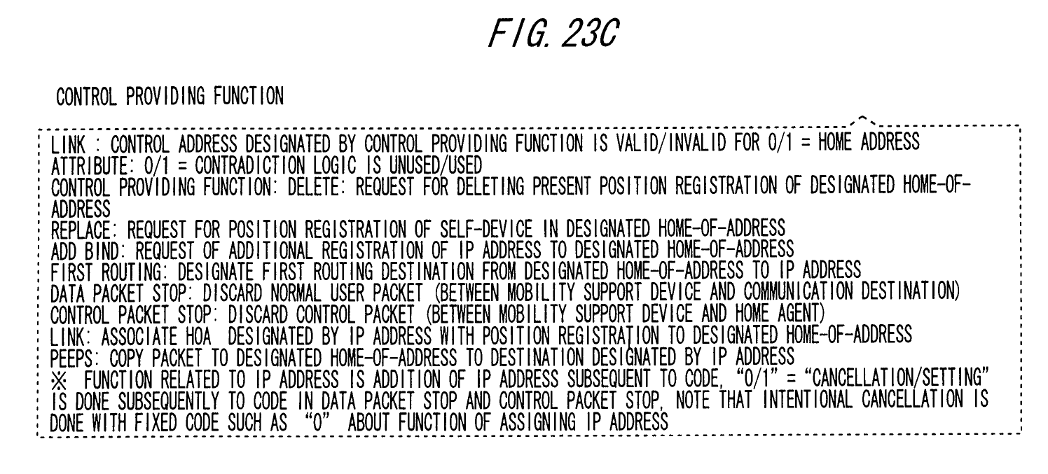

FIG. 23A is a diagram showing an example of a plural HoA registration request message. FIG. 23B is an explanatory diagram showing in depth the plural HoA registration request shown in FIG. 23A. FIG. 23C is an explanatory diagram showing a content of plural HoA-related registration processing information. This message is generated based on the content set in the table 60 as shown in FIG. 20A. As illustrated in FIG. 23B, the plural HoA registration request message has a field of the plural HoA registration request, wherein the plural HoA-related registration processing information provided in this field contains the settings of the contents (the link, the attribute, P2 and the control providing function) of the entry associated with the designated HOA in the table 60 (see FIG. 20A) on the message transmitting side. Further, the contents (the link, the attribute, P2 and the control providing function) set in the message are reflected in (mapped to) the entry of the associated HoA in the table 60 on the message receiving side. The thus-structured message is sent to the home agent from the management node. At this time, if the message shows a registration mode, the home agent registers, in the entry of the table 60, the control providing function associated with the HoA in the message. Further, the message shows a setting mode, the home agent performs a control operation based on the control providing function associated with the HoA in the message.

FIG. 24 is a diagram showing a normal binding refresh request message. This type of message can be applied to the seventh and eighth embodiments.

FIG. 25 is a diagram showing an example of a stop message applicable to the seventh and eighth embodiments. As shown in FIG. 25, a header containing the option type is inserted into the mobile IP message, wherein a normally unused code value, which is a value indicating “stop”, is set as a value of this option type. The MN is constructed to include the detection unit (the node stop code check unit 38) for detecting the code value indicating the stop and the means (the application 34) that, if the code value indicating the stop is detected, stops the MN or sets the MN in an unusable status.

### Process by HA

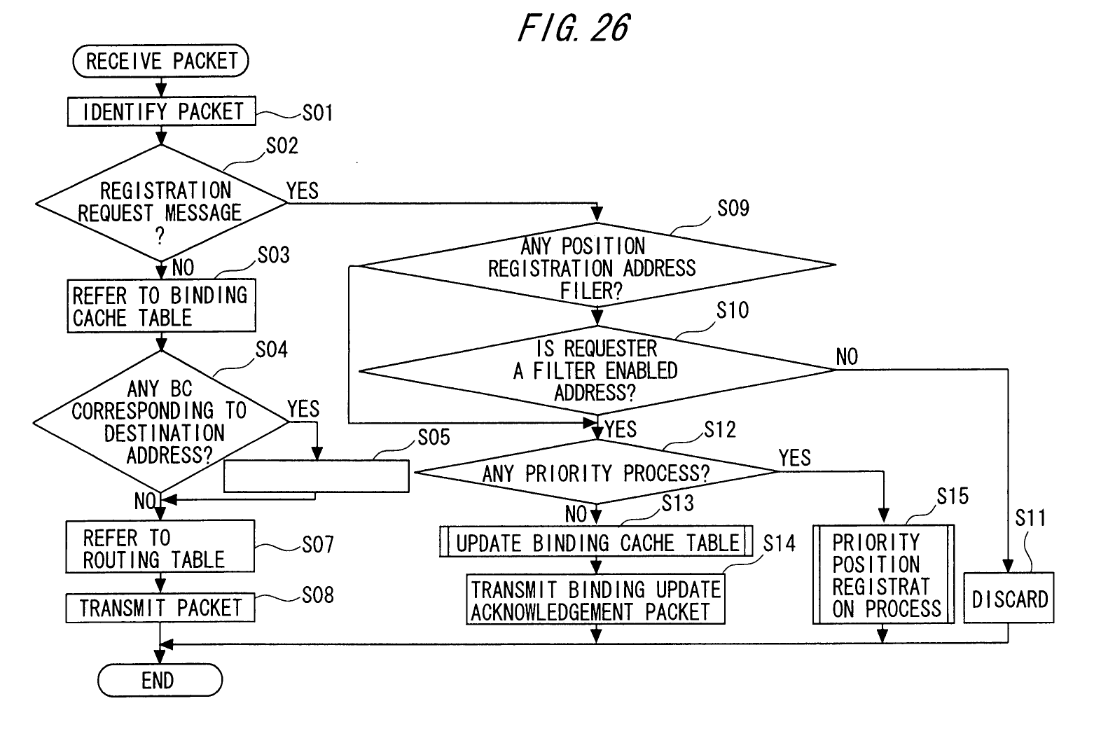

Next, a process executed by the HA explained in the embodiments of the present invention discussed above, will be described. FIG. 26 is a flowchart showing the process by the HA. The flowchart is started as triggered by receiving the packet.

The HA, upon receiving the packet, executes an identifying process of this packet (S01), and judges whether or not this packet contains the binding update (BU) request (registration request message) (S02). At this time, in the case of judging that the binding update message is contained (S02; Yes), the processing proceeds to step S09 and, whereas if not (S02; No), proceeds to step S03.

In step S03, the HA refers to the BC table and thus judges whether or not there exists a BC associated with the destination address of the packet (S04). At this time, when judging that there is none of such a BC (S04; No), the processing proceeds to step S07 and, whereas if not (S04; Yes), proceeds to step S05.

In step S05, in an encapsulation process, the packet is encapsulated, wherein the care-of-address CoA in the BC is, set as a destination address. Thereafter, the processing proceeds to step S07.

In step S07, the HA specifies a transmission port of the packet by referring to the routing table, and, in step S08, forwards the packet to the network from the transmission port, thereby finishing the processing.

When the processing proceeds to step S09, the HA judges whether a position registration (binding update) address filter, i.e., the address filter for restricting the source of the BU is set or not. At this time, when judging that the address filter exists (S09; Yes), the processing proceeds to step S010 and, whereas if not (S09; No), proceeds to step S12.

In step S10, the HA judges whether or not the requester, i.e., the source address of the BU message is a filter permission address (which is an address of the node having authority (binding update authority) for sending the BU message). At this time, when judging that this source address corresponds to the filter permission address (S10; Yes), the processing proceeds to step S12 and, whereas if not (S10; No), the packet is discarded (S11), thereby terminating the processing.

In step S12, the HA judges whether or not the setting is done to execute the priority process, i.e., to execute the update process based on the priority level. At this time, if set to execute the priority process (S12; Yes), the HA executes the priority position registration (binding update) process (S15), and thereafter finishes the process. By contrast, if set not to execute the priority process (S12; No), the HA updates the BC table on the basis of the BU message (S13), and generates and sends a position registration acknowledgement (binding acknowledgement) packet (BA message) based on a result of this update (S14), thereby terminating the process.

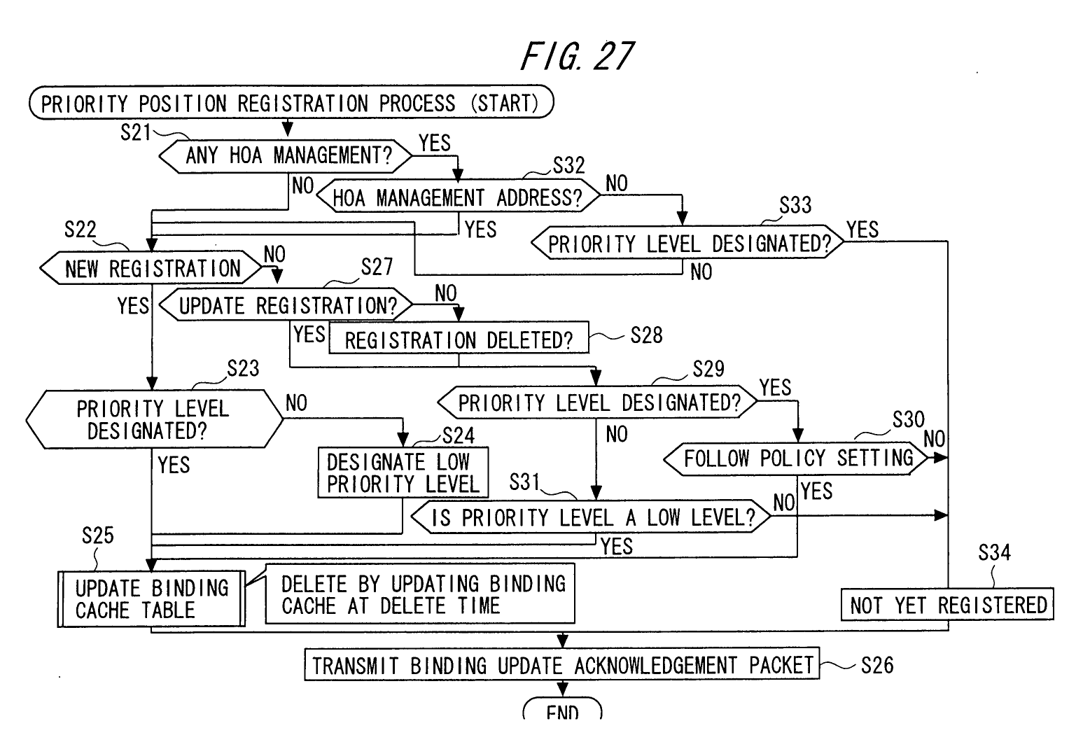

FIG. 27 is a flowchart showing an example of the priority position registration process shown in FIG. 26. In FIG. 27, the HA, upon starting the process, to being with, judges whether there is HoA management or not (S21). The HA proceeds with the processing to step S32 if there is the HoA management (S21; Yes) and, whereas if not (S21; No), proceeds with the processing to step S22.

In step S22, the HA judges whether the position registration is new registration or not by referring to the binding based on the BU message and to the registration contents in the BC table, then proceeds with the processing to step S23 if being the new registration (S22; Yes) and, whereas if not (S22; No), proceeds with the processing to step S227.

In step S23, the HA judges whether or not the priority is designated in the BU message, then proceeds with the processing to step S25 if the priority level is designated (S23; Yes) and, whereas if not (S23; No), proceeds with the processing to step S25 after designating a low priority level (S24).

In step S25, the HA executes a process of updating the BC table. To be specific, the HA registers the binding specified from the BU message and the designated priority level in the BC table as shown in, e.g., FIG. 16. Thereafter, the HA sends the BA message in response to the BU message (S26) and terminates the process.

When the processing proceeds to step S27, the HA judges whether or not the position registration is the update registration and, if so (S27; Yes), proceeds with the processing to step S29. In step S29, the HA judges whether or not the priority level is designated in the BU message, and, if the priority level is designated (S29; Yes), proceeds with the processing to step S30.

In step S30, the HA compares the priority level (which is referred to as a [designated priority level]) contained in the BU message with the priority level (which is termed a [registered priority level]) registered in the update target BC, and judges which priority level is superior according the preset policy. For instance, if the designated priority level is higher than the registered priority level, the processing proceeds to S25 and, if the designated priority level is equal to or lower than the registered priority level, proceeds to S34.

When the processing advances to S25, the HA updates (overwrites) the entry in the update target BC table with the BU-based binding and priority level. Accordingly, the previously-registered binding and priority level are deleted. Thereafter, the BA message representing the update of the BC is sent, and the processing comes to an end. On the other hand, when the processing advances to step S34, the HA sends, without updating the BC, the BA message showing that the BC is not yet updated, and terminates the process.

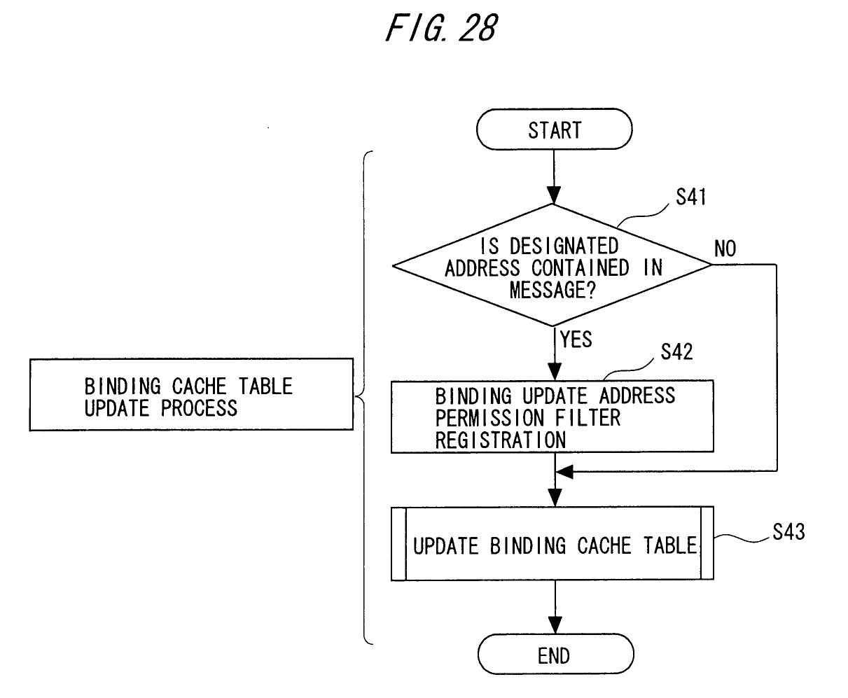

FIG. 28 is a flowchart showing a designation process, executed by the HA, of designating a valid address (setting-enabled address) in the BC. The process shown in FIG. 28 is, in such a case that the BC as shown in FIG. 19 is applied and that the nodes capable of updating the BC are limited, executed in the process in, e.g., step S25 shown in FIG. 27.

In FIG. 28, the HA judges whether or not the message (which is e.g., the BU message and can involve applying other mobile IP messages) contain a should-be-set designated address as the setting-enabled address (S41).

At this time, if the designated address is not contained, the processing proceeds to step S43, and, whereas the designated address is contained, the HA registers, as a position registration (binding update) address permission filter registration process, the designated address as the setting-enabled address and thereafter proceeds with the processing to step S43.

In step S43, the HA updates, as a BC table update process, the BC table with the BU-message-based binding and priority level. Thereafter, the processing comes to an end.

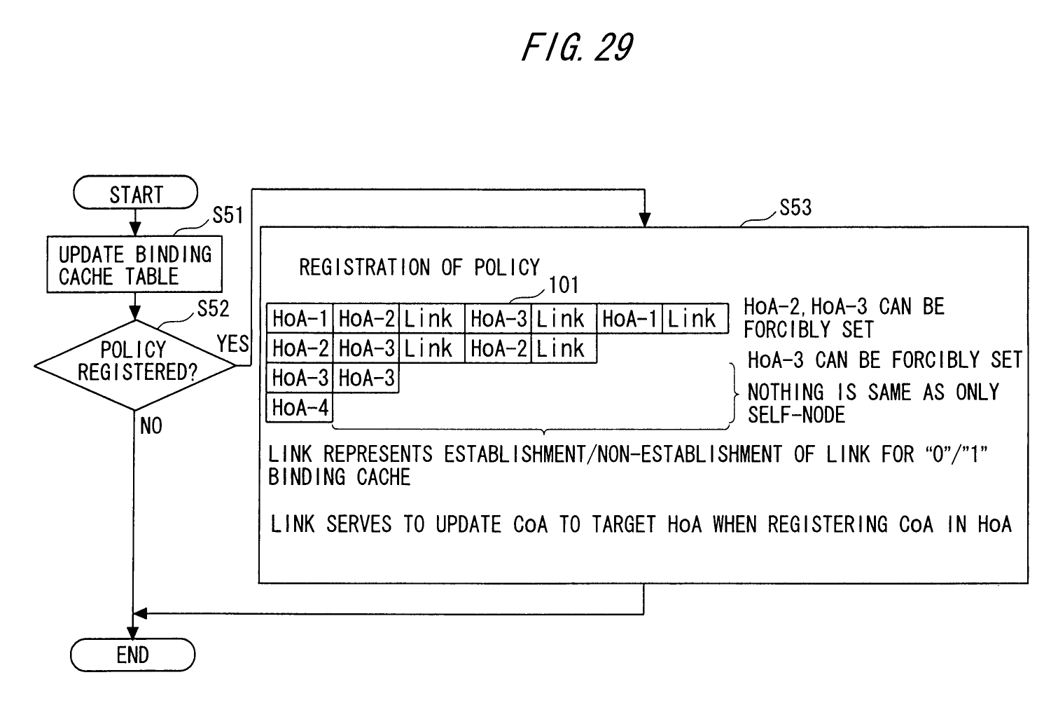

FIG. 29 is a flowchart showing a policy-related process registration process. This process is, as explained, e.g., in the fifth embodiment, executed in the case of reflecting the registration of a certain binding in other bindings. This process involves using a policy registration table 101 as shown in FIG. 29.

The policy registration table 101 shown in FIG. 29 is stored with information showing whether or not the update is done with respect to four pieces of HoAs (HoA-1, HoA-2, HoA-3, HoA-4) as target HoAs. Specifically, the HoA (associated HoA) associated with the target HoA and its link are stored for every target HoA. The same HoA as the target HoA can be selected as the associated HoA. The link has values of “0” and “1”, wherein when the value is “1”, this value represents that the care-of-address CoA registered in the binding cache BC of the target HoA is updated with the CoA bound to the associated HoA, and, when the value is “0”, this value represents that the BC of the target HoA is not updated. The meanings of the values “0” and “1” may be reversed.

To describe it by taking “HoA-1” as the target HoA for example, HoA-2, HoA-3 and HoA-1 are set as the associated HoAs in the entry of HoA-1. Herein, the priority levels are set such as HoA-2>HoA-3>HoA-1. When the link value of each associated HOA is “1”, the care-of-address CoA in the BC of HoA-1 is, in addition to updating HoA-1, forcibly updated when registering or updating HoA-2 and HoA-3.

Upon a start of the process shown in FIG. 29, the HA updates the BC table and registers the binding based on the BU message in the BC table (S51). At this time, if the BU message contains the designation of the priority level, this priority level is also registered.

Next, the HA judges whether the policy registration is made or not (S52). Namely, the HA refers to the policy registration table 101 and thus judges whether or not the HoA of the binding registered in S51 corresponds to the associated HoA of which the link value is “1”. At this time, the processing is finished if the HoA does not correspond to the associated HoA (S52; No) but proceeds to S53 whereas if the HoA corresponds to the associated HoA (S52; Yes).

In step S53, the home agent HA specifies the target HoA from the policy registration table 101, further specifies the BC of this target HoA from the BC table, and rewrites the CoA (of the binding) registered in this BC into the CoA bound to the associated HoA registered in S51. Then, the HA terminates the process. Thus, on the occasion of registering the binding related to a certain HoA, it is possible to rewrite the CoA of the binding related to one other HoA.

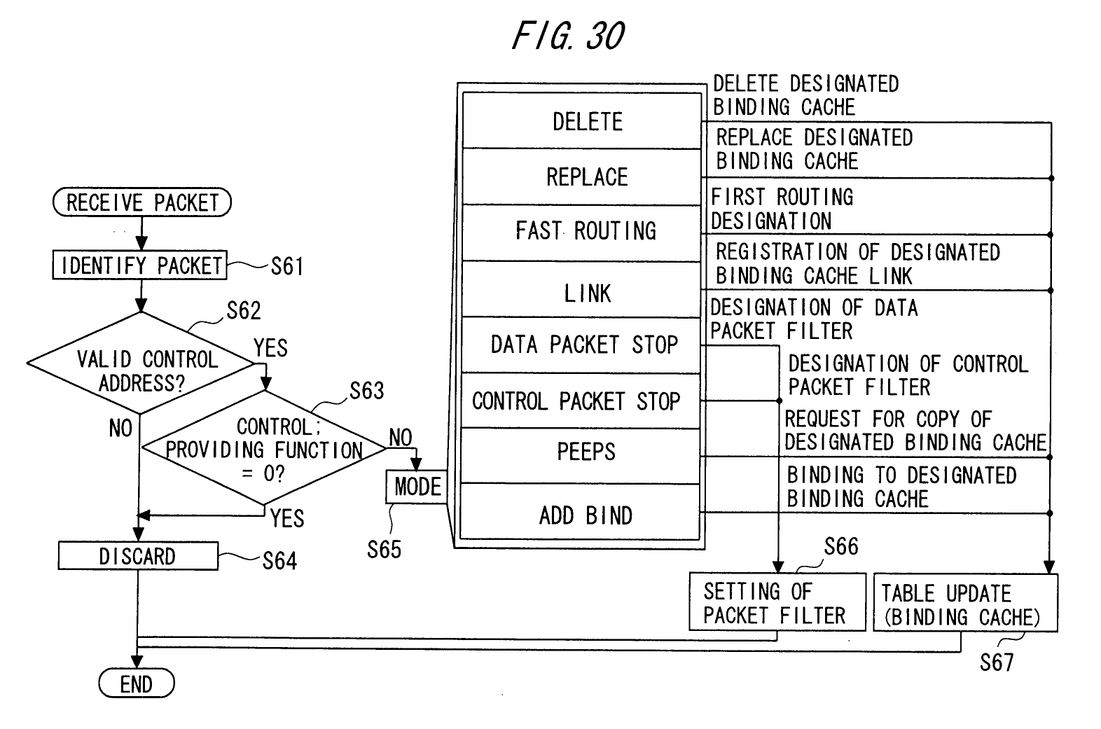

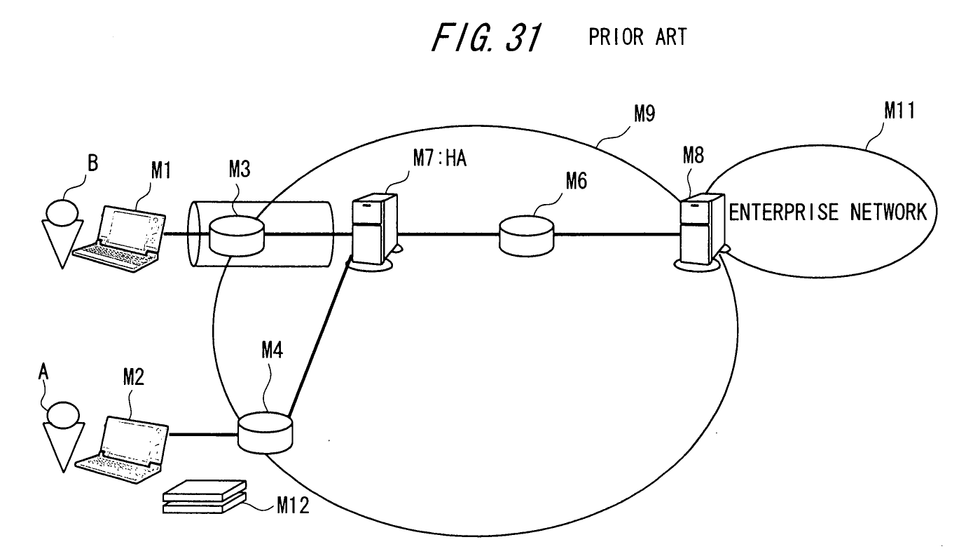

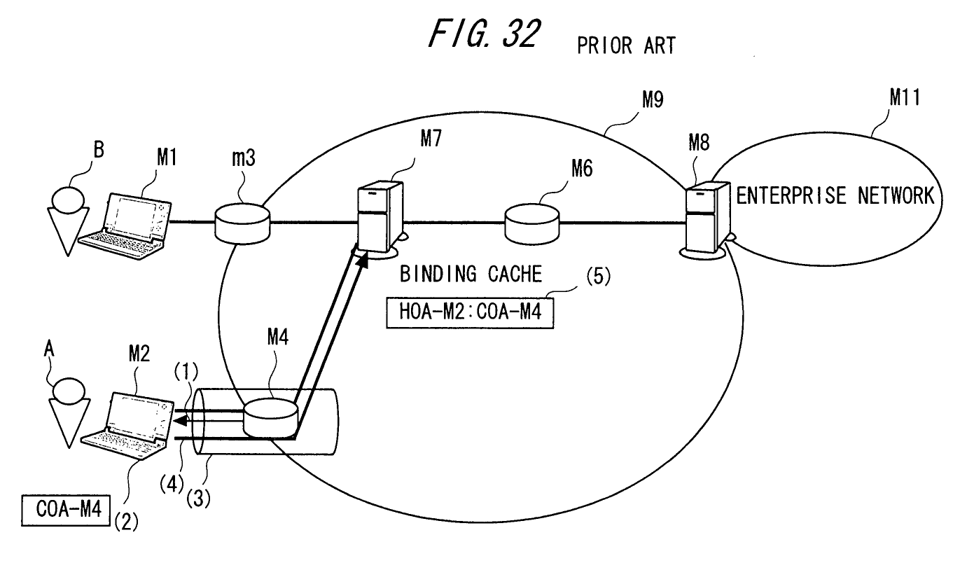

FIG. 30 is a flowchart showing a plural HoA-related process request. The process shown in FIG. 20 is executed in such a case that the table shown in FIG. 20 and the message shown in FIG. 23 are applied. These structures are applied in a mode, wherein the mobile node and the management node execute the control for the HA.

In FIG. 30, the HA starts the process as triggered by receiving the message packet shown in FIG. 23. At first, the HA identifies the packet (S61), then judges whether or not the source address of this packet is a valid control address (S62), and, if not, discards this packet (S64), thereby terminating the process.

Whereas if the source address of the packet is the valid control address, the HA judges whether a value in the control providing function is “0” or not, then proceeds with the processing to step S64 if the value is “0” and proceeds with the processing to step S65 whereas if not. In step S65, the HA refers to the MODE (mode) value, then executes a policy registration process if this MODE value represents a registration mode (SET) (see FIG. 20(B)), and executes a process based on a content of the policy registration if being a setting (request) mode (WRITE). FIG. 30 shows the process in the case where the MODE value indicates the setting mode. In step S65, the HA executes a process based on a content of the control providing function (see FIG. 20(B)), wherein the HA sets the packet filter (S66) and updates the BC table (S67). Then, the processing comes to an end.

### Operational Effects in Embodiments

According to the embodiments, the user of the mobile node MN, if the position registration (binding update) in the HA gets into a failure due to the unauthorized position registration, the position registration exhibiting the high priority level is conducted from on the node different from the node that is now performing the position registration, whereby the unauthorized position registration can be deleted. Furthermore, the unauthorized position registration can be also deleted from on the management node of the HA. Moreover, the management node can request the HA to change the security policy.

Further, in the case where the unauthorized position registration is done, the HA changes the destination address of the packet transmitted from this MN, thereby enabling the predetermined node to receive the packet.

Moreover, if the user suffers a loss or a theft of the MN, the BRR message is sent from the management node via the HA, the position of the MN can be grasped. Further, in the case that the position registration (binding update) of the MN is set in the HA, the management node sends the stop message to the MN, thereby making it possible to prevent others from abusing the MN.

### Others

The disclosures of international application PCT/JP2003/016369 filed on Dec. 19, 2003 including the specification, drawings and abstract are incorporated herein by reference.

What is claimed is:

1. A mobility support apparatus for a mobile terminal, having a storage unit stored with position information of said mobile terminal and controlling communications of said mobile terminal on the basis of the position information registered in said storage unit, said mobility support apparatus comprising:
a priority level registering unit that registers a priority level of the position information registered in said storage unit;
a communication unit; and
an update processing unit that judges, with respect to a position information update request received by said communication unit, whether or not a priority level contained in the position information update request is higher than a priority level of an update target position information within said storage unit, and updates, when judging that the priority level contained in the position information update request is higher, the update target position information with the position information contained in the position information update request.

2. A mobility support apparatus for a mobile terminal according to claim 1, wherein said update processing unit executes the judging process about the update request sent from said mobile terminal.

3. A mobility support apparatus for a mobile terminal according to claim 1, wherein said update processing unit executes the judging process about the update request sent from a management terminal of said mobility support apparatus.

4. A mobility support apparatus for a mobile terminal, having a storage unit stored with position information of said mobile terminal and controlling communications of said mobile terminal on the basis of the position information registered in said storage unit, said mobility support apparatus comprising:
a communication unit; and
an update processing unit that receives a position information update request containing first position information from a management terminal of said mobility support apparatus via said communication unit, rewrites update target position information within said storage unit with the first position information, thereafter receives a position information update request containing second position information from said mobile terminal via said communication unit, and rewrites the first position information within said storage unit into the second position information.

5. A mobility support apparatus for a mobile terminal according to claim 1, further comprising:
a time measuring unit that measures a predetermined period of time when said storage unit is stored with the position information in which a highest priority level is set; and
a rewriting unit that rewrites, when said time measuring unit measures the predetermined period of time, the highest priority level into a lower priority level.

6. A mobility support apparatus for a mobile terminal according to claim 1, wherein said update processing unit, when registering the position information containing the setting of the highest priority level in said storage unit, registers the position information in a way that assigns this information a priority level lower than the highest priority level.

7. A mobility support apparatus for a mobile terminal according to claim 1, wherein said update processing unit accepts, only when a sender of the position information update request received by said communication unit is a predetermined node, this position information update request.

8. A mobility support apparatus for a mobile terminal, having a storage unit stored with position information of said mobile terminal and controlling communications of said mobile terminal on the basis of the position information registered in said storage unit, said mobility support apparatus comprising:
a communication unit; and
an update processing unit that receives a position information update request sent from said mobile terminal having plural pieces of identifying information via said communication unit, and updates, if the storage unit is stored with the position information containing the mobile terminal identifying information different from the mobile terminal identifying information contained in the position information in this update request, the position information within said storage unit on the basis of the position information in the update request.

9. A mobility support apparatus for a mobile terminal according to claim 1, further comprising:
a transfer destination setting unit that sets transfer destination information of a packet in the position information stored in said storage unit; and
a transfer control unit that forwards, if a sender of the packet received by said communication unit is said mobile terminal associated with the position information in which the transfer destination information is set, this packet toward a transfer destination based on the transfer destination information from said communication unit.

10. A mobility support apparatus for a mobile terminal according to claim 9, wherein said transfer control unit, if a destination (recipient) of the packet received by said communication unit is said mobile terminal associated with the position information in which the transfer destination address is set, this packet toward a transfer destination based on the transfer destination information from said communication unit.

11. A mobility support apparatus for a mobile terminal according to claim 1, further comprising:
a unit that sets in a packet transmission-enabled status, in response to a request from a predetermined terminal, said mobile terminal associated with predetermined position information stored in said storage unit; and
a relay processing unit that transmits, if the sender of the packet received by said communication unit is said predetermined terminal, this packet to said mobile terminal from said communication unit in accordance with the transmission-enabled status.

12. A mobility support apparatus for a mobile terminal according to claim 11, wherein said relay processing unit rewrites a source address of the packet that should be transferred to said mobile terminal into an address of said mobility support apparatus.

13. A mobility support apparatus for a mobile terminal according to claim 11, wherein said relay processing unit relays a packet containing a message by which said mobile terminal is forced to send the position information update request.

14. A mobility support apparatus for a mobile terminal according to claim 11, wherein said relay processing unit relays a packet containing a message for stopping an operation of said mobile terminal.

15. A mobility support apparatus for a mobile terminal according to claim 11, further comprising:
a registering unit that registers controlled target information representing a control target by said management terminal in specified position information stored in said storage unit in response to a request given from said management terminal; and
a control unit that executes a process related to the position information containing the registration of the controlled target information on the basis of the control information received by said communication unit and given from said management terminal.

16. A mobile communication system comprising:
a mobile terminal;
a first mobility support apparatus;
a second mobility support apparatus; and
a gateway disposed in a private network accessed by said mobile terminal,
wherein said first mobility support apparatus accepts position registration from said mobile terminal and from said gateway, and establishes communications between said mobile terminal and said gateway via said first mobility support apparatus itself, and
said second mobility support apparatus accepts, when judging that said mobile terminal is unable to perform the communications with said gateway via said first mobility support apparatus due to a rise in load on said first mobility support apparatus, the position registration from said mobile terminal and from said gateway, and establishes the communications between said mobile terminal and said gateway via said second mobility support apparatus itself.

17. A mobile communication system comprising:
a mobile terminal;
a mobility support apparatus; and
first and second gateways disposed in a private network accessed by a mobile terminal,
wherein said mobility support apparatus accepts position registration from said mobile terminal and from said first gateway, and establishes communications between said mobile terminal and said first gateway via said mobility support apparatus itself, and
said second gateway makes, if a load on said first gateway exceeds a predetermined value, the position registration in a way that serves as said first gateway in said mobility support apparatus, and takes over the communications with said mobile terminal from said first gateway.

18. A mobile communication system according to claim 17, wherein said second gateway performs, when taking over the communications with said mobile terminal from said first gateway, a test as to whether said mobile terminal is an unauthorized mobile terminal or not, and requests, when judging from a result of the test that said mobile terminal is the unauthorized mobile terminal, said mobility support apparatus to execute a process of disconnecting the communications with said mobile terminal.
